(19) United States
(12) Patent Application Publication
(10) Pub. No.: US 2006/0161430 A1
(43) Pub. Date: Jul. 20, 2006

(54) Voice activation

(75) Inventor: Detlef Schweng, Weinstadt-Schnait (DE)

Correspondence Address: GEORGE O. SAILE, 28 DAVIS AVENUE, POUGHKEEPSIE, NY, 12603, US

(73) Assignee: Dialog Semiconductor Manufacturing Ltd

(21) Appl. No.: 11/184,526

(22) Filed: Jul. 19, 2005

(30) Foreign Application Priority Data
Jan. 14, 2005 (EP) 05368003.9

(51) Int. Cl. G10L 15/20

(52) U.S. Cl. 704/233

(57) ABSTRACT

A circuit and a method are given, to realize a very flexible voice activation system using a modular building block approach, that is adaptively tailored to handle certain relevant and case specific operational characteristics describing most of the possible acoustical differing environmental cases to be found in the field of speech recognition. Included are determinations of “Noise estimation and “Speech estimation” values, done effectively without use of Fast Fourier Transform (FFT) methods or zero crossing algorithms only by analyzing the modulation properties of human voice. Said circuit and method are designed in order to be implemented with a very economic number of components, capable to be realized with modern integrated circuit technologies.

### BACKGROUND OF THE INVENTION

(1) Field of the Invention

The present invention generally relates to speech detection and/or recognition and more particularly to a system, a circuit and a concomitant method thereof for detecting the presence of a desired signal component within an acoustical signal, especially recognizing a component characterizing human speech. Even more particularly, the present invention is providing a human speaker recognition by means of a detection system with automatically generated activation trigger impulses at the moment a voice activity is detected.

(2) Description of the Prior Art

Sound or acoustical signals are besides others, such as video signals e.g., one main category of analog and—most often also noise polluted—signals modern telecommunications are dealing with; where all signals together—generally after transformation into digital form—are termed as communication data signals. Analyzing and processing such sound signals is an important task in many technical fields, such as speech transmitting and voice recording and becoming even more relevant nowadays, speech pattern or voice recognition e.g. for a command identification to control modern electronic appliances such as mobile phones, navigation systems or personal data assistants by spoken commands, for example to dial the phone number with phones or entering a destination address with navigation systems. In real world environments, many observed acoustical signals to be processed are typically composites of a plurality of signal components. Looking at an audio signal picked up by a microphone within a moving vehicle, the enregistered audio signal may comprise a plurality of signal components, such as audio signals attributed to the engine and the gearbox of the car, the tires rolling on the surface of the road, the sound of wind, noise from other vehicles passing by, speech signals of people chatting within the vehicle and the like. Furthermore, most audio signals are non-stationary, since the signal components vary in time as the situation is changing. In such real world environments, it is often necessary to detect the presence of a desired signal component, e.g., a speech component in an audio signal. Speech detection has many practical applications, including but not limited to, voice or speech recognition applications for spoken commands. Such applications of speech detection as in Voice Operated Trans-(X)-mission (VOX) systems or in baby phones need to have a voice activation module included in order to decide when a voice signal starts so as to generate an activation trigger impulse. Normally the sound level is used for this purpose. The disadvantage thereby is, that—without additional precautions—some kind of noise can also lead to an activation signal. The invention reduces such a misclassification by detecting voice only appearance in a more reliable manner. For speech recognition as known in the art this is an advantageous feature. In general, speech audio input is digitized and then processed to facilitate identification of specific spoken words contained in the speech input. Pursuant to one approach called pattern-matching, so-called features are extracted from the digitized speech and then compared against previously stored patterns to enable such recognition of the speech content. It is easily understandable that, in general, pattern matching can be more successfully accomplished when the input can be accurately characterized as being either speech or non-speech audio input. For example, when information is available to identify a given segment of audio input as being non-speech, that information can be used to beneficially influence the functionality of the pattern matching activity by, for example, simplifying or even eliminating said pattern matching for that particular non-speech segment. Unfortunately, the benefits of voice activity detection are not ordinarily available in speech recognition systems, as the identification of speech is very complex, time-consuming and costly and also considered being not reliable enough. This is where this invention might also come in.

The main problems in performing a reliable human speech detection and voice activation lie in the fact, that the speech detection procedures have to be adapted to all the possible environmental and operational situations in such a way, that always the most apt procedures i.e. algorithms and their optimum parameters are chosen, as no unique procedure on its own is capable of fulfilling all the desired requirements under all conditions. In order to substantiate said situations a bit more, showing all the diversity of environmental and operational situations, a rather casual catalog of questions to be considered is given in the following, whereby no claim for completeness is made. This list of questions is given in order to decide which algorithm is best suited for the specific application and thus illustrates the vast range of possible considerations to be made.

Such questions may be, for example, questions about the audio signal itself, about the environment, about technical and manufacturing aspects, such as:
Is the audio signal loudness high or low in comparison to background noise?
Is the audio signal consisting of speech, baby sounds or artificial sound?
Is the environment a quiet one, or with a constant background noise level or even with a changing background noise level?
Is the application to be used in a room, such as a church e.g. (reverberation issue) or outdoors?
Are one or more microphones used for signal pick-up?
Is the microphone positioned near to or far away from the mouth of the speaker?
Is the microphone, amplifier and codec depending on or adjusted to the user?
Is the microphone amplification manually adjustable by the user or automatically?
Are short reaction times a desired feature?
How important is the reliability of the activation and/or are only very few classification errors allowed?
Which importance do power consumption, necessary chip area, production price and project time schedule for the realization have?

And so on. Depending on the outcome of the answers to these questions it will then be decided, which algorithm is best suited for the specific application. Some relevant answers to these questions will be given later.

Preferred prior art realizations are implementing speech detection and voice activation procedures via single chip or multiple chip solutions as integrated circuits. These solutions are therefore on one hand, only usable with optimum results for certain well defined cases, thus exhibiting however a somewhat limited complexity or are on the other hand very complex and use extremely demanding algorithms requiring great processing power, thus offering however greater flexibility with respect to their adaptability. The limitation in applicability of such a low-cost circuit on one hand and the complexity and the power demands of such a higher quality circuit on the other hand are the main disadvantages of these prior art solutions. These disadvantages pose major problems for the propagation of that sort of circuits. It is therefore a challenge for the designer of such devices and circuits to achieve a high-quality and also low-cost solution.

Several prior art inventions referring to such solutions describe related methods, devices and circuits, and there are also several such solutions available with various patents referring to comparable approaches, out of which some are listed in the following:

U.S. Pat. No. 6,691,087 (to Parra et al.) shows a method and an apparatus for adaptive speech detection by applying a probabilistic description to the classification and tracking of signal components, wherein a signal processing system for detecting the presence of a desired signal component by applying a probabilistic description to the classification and tracking of various signal components (e.g., desired versus non-desired signal components) in an input signal is disclosed.

U.S. Pat. No. 6,691,089 (to Su et al.) discloses user configurable levels of security for a speaker verification system, whereby a text-prompted speaker verification system that can be configured by users based on a desired level of security is employed. A user is prompted for a multiple-digit (or multiple-word) password. The number of digits or words used for each password is defined by the system in accordance with a user set preferred level of security. The level of training required by the system is defined by the user in accordance with a preferred level of security. The set of words used to generate passwords can also be user configurable based upon the desired level of security. The level of security associated with the frequency of false accept errors verses false reject errors is user configurable for each particular application.

U. S. Patent Application 20020116186 (to Strauss et al.) describes an integrated voice activity detector for integrated telecommunications processing for detecting whether voice is present. In one embodiment, the integrated voice activation detector includes a semiconductor integrated circuit having at least one signal processing unit to perform voice detection and a storage device to store signal processing instructions for execution by the at least one signal processing unit to: detect whether noise is present to determine whether a noise flag should be set, detect a predetermined number of zero crossings to determine whether a zero crossing flag should be set, detect whether a threshold amount of energy is present to determine whether an energy flag should be set, and detect whether instantaneous energy is present to determine whether an instantaneous energy flag should be set. Utilizing a combination of the noise, zero crossing, energy, and instantaneous energy flags the integrated voice activation detector determines whether voice is present.

U. S. Patent Application 20030120487 (to Wang) describes the dynamic adjustment of noise separation in data handling, particularly voice activation wherein data handling dynamically responds to changing noise power conditions to separate valid data from noise. A reference power level acts as a threshold between dynamically assumed noise and valid data, and dynamically refers to the reference power level changing adaptively with the background noise. The introduction of dynamic noise control in VOX (Voice Activated Transmission) improves a VOX device operation in a noisy environment, even when the background noise profiles are changing. Processing is on a frame by frame basis for successive frames. The threshold is adaptively changed when a comparison of frame signal power to the threshold indicates speech or the absence of speech in the compared frame repeatedly and continuously for a period of time involving plural successive frames having no valid speech or noise above the threshold to correspondingly reduce or increase the threshold by changing the threshold to a value that is a function of the input signal power.

U. S. Patent Application 20040030544 (to Ramabadran) describes a distributed speech recognition with back-end voice activity detection apparatus and method, where a back-end pattern matching unit can be informed of voice activity detection information as developed through use of a back-end voice activity detector. Although no specific voice activity detection information is developed or forwarded by the front-end of the system, precursor information as developed at the back-end can be used by the voice activity detector to nevertheless ascertain with relative accuracy the presence or absence of voice in a given set of corresponding voice recognition features as developed by the front-end of the system.

Although these papers describe circuits and/or methods close to the field of the invention they differ in essential features from the method, the system and especially the circuit introduced here.

### SUMMARY OF THE INVENTION

A principal object of the present invention is to realize a very flexible and adaptable voice activation circuits module in form of very manufacturable integrated circuits at low cost.

Another principal object of the present invention is to provide an adaptable and flexible method for operating said voice activation circuits module implementable with the help of integrated circuits.

Also another principal object of the present invention is to include determinations of “Noise estimation and “Speech estimation” values, done effectively without use of Fast Fourier Transform (FFT) methods or zero crossing algorithms only by analyzing the modulation properties of human voice.

Also an object of the present invention is to include tailorable operating features into a modular device for implementing multiple voice activation circuits and at the same time to reach for a low-cost realization with modern integrated circuit technologies.

Further an object of the present invention is to always operate the voice activation device with its optimum voice activation algorithm.

Also further an object of the present invention is the inclusion of multiple diverse voice activation algorithms into the voice activation device.

Another further object of the present invention is to combine the function of multiple diverse voice activation algorithms within the voice activation device operating.

Also an object of the present invention is to establish a building block system for a voice activation device, capable of being tailored to function effectively under different acoustical conditions.

Also another object of the present invention is to facilitate by said building block approach for said voice activation device solving operating problems necessitating future expansions of the circuit.

Further another object of the present invention is to streamline the production by implementing the voice activation device with a limited gate count, i.e. to limit its complexity counted by number of transistor functions needed.

A further object of the present invention is to make the voice activation circuit as flexible as possible by previsioning modules and interconnections necessary to implement algorithms of future developments.

A still further object of the present invention is to reduce the power consumption of the circuit by realizing inherent appropriate design features.

Another further object of the present invention is to reduce the cost of manufacturing by implementing the circuit as a monolithic integrated circuit in low cost CMOS technology.

Another still further object of the present invention is to reduce cost by effectively minimizing the number of expensive components.

In accordance with the objects of this invention, a new system for a tailorable and adaptable implementation of a voice activation function is described, capable of a practical application of multiple voice activation algorithms, receiving an audio input signal and furnishing a trigger impulse as output signal, comprising an analog audio signal pick-up sensor; an analog/digital converting means digitizing said audio signal and thus transforming said audio signal into a digital signal, then named ‘Digital Audio Input Signal’; a modular assembly of multiple voice activation algorithm specific circuits made up of building block modules containing processing means for amplitude and energy values of said ‘Digital Audio Input Signal’ as well as and especially for Noise and Speech estimation calculations, intermediate storing means, comparing means, connecting means and means for selecting and operating said voice activation algorithms; and a means for generating said trigger impulse.

Also in accordance with the objects of this invention, a new method for a general tailorable and adaptable voice activation circuits system is described, capable of implementing multiple diverse voice activation algorithms with an input terminal for an audio input signal and an output terminal for a generated voice activation trigger signal and being composed of four levels of building block modules together with two levels of connection layers, altogether being dynamically set-up, configured and operated within the framework of a flexible timing schedule, comprising at first providing as processing means—four first level modules named “Amplitude Processing” block, “Energy Processing” block, “Noise Processing” block and “Speech Processing” block, which act on its input signal named ‘Digital Audio Input Signal’ either directly or indirectly, i.e. either on its amplitude value as input variable or on processed derivatives thereof, i.e. on energy, noise and speech values as processing variables; providing as storing means four pairs of second level modules designated as value and threshold storing blocks or units respectively, namely for intermediate storage of pairs of amplitude, signal energy, noise energy and speech energy values in each case, named “Amplitude Threshold” and “Amplitude Value”, “Energy Threshold” and “Energy Value”, “Noise Threshold” and “Noise Energy Value”, as well as “Speech Threshold” and “Speech Energy Value”; providing as comparing means within a third level of modules four comparator blocks, named “Amplitude Comparator”, “Energy Comparator”, “Noise Comparator”, and “Speech Comparator”; providing as triggering means and fourth module level an “IRQ Logic” block together with its “IRQ Status/Config” block, delivering an IRQ output signal for voice activation; providing also a “First Interconnection Layer” within and between said first level modules for processing said ‘Digital Audio Input Signal’ values from its amplitude, energy, noise and speech variables and said second level modules, whereby said amplitude value of said ‘Digital Audio Input Signal’ may be fed into said “Amplitude Processing” block, and/or into said “Energy Processing” block, and/or into said “Noise Processing” block and/or into said “Speech Processing” block, thus receiving from each other already processed values as possible input and/or control signals separately or in parallel and whereby finally from all said processing the resulting variables with their calculated and/or estimated values are fed into said respective second level storing units, named “Amplitude Value”, “Signal Energy Value”, “Noise Energy Value”, and “Speech Energy Value”; providing further a “Second Interconnection Layer” between said second and third level of modules for storing and comparing said processed values of said amplitude, energy, noise (SNR) and speech variables, whereby always the corresponding values of threshold and variable result pairs are fed into their respective comparator blocks located within said third level of modules and whereby said comparator blocks may also receive via an extra input additional control signals from others of said second level modules; providing an extra “Config” block for setting-up and configuring all necessary threshold values and operating states for said blocks within all four levels of modules according to said voice activation algorithm to be actually implemented; connecting the output of each of said comparators in module level three to said fourth level “IRQ Logic” block as inputs; establishing a recursively adapting and iteratively looping and timing schedule as operating scheme for said tailorable voice activation circuits system capable of implementing multiple diverse voice activation algorithms and thus being able to being continuously adapted for its optimum operation; initializing with pre-set operating states and pre-set threshold values a start-up operating cycle of said operating scheme for said voice activation circuit; starting said operating scheme for said adaptable voice activation circuits system by feeding said ‘Digital Audio Input Signal’ as sampled digital amplitude values into the circuit, namely said “First Interconnection Layer”, for further processing e.g. by calculating said signal energy, and/or by estimating said noise energy and/or said speech energy; deciding upon said voice activation algorithm to be chosen for actual implementation with the help of crucial variable values such as said amplitude value from said audio signal input variable and also said already calculated and estimated signal energy, noise energy and speech energy values as processing variables critical and crucial for said voice activation algorithm and in conjunction with some sort of a decision table, leading to optimum choices for said voice activation algorithms; setting-up the operating function of said “First Interconnection Layer” element appropriately with the help of said “Status/Config” block considering the requirements of said voice activation algorithm to be actually implemented for the connections within and between said first and second level modules; setting-up the operating function of said “Second Interconnection Layer” element appropriately with the help of said “Status/Config” block considering the requirements of said voice activation algorithm to be actually implemented for the connections within and between said second and third level modules; configuring said necessary operating states e.g. in internal modules each with specific registers by algorithm defining values corresponding to said actually chosen voice activation algorithm for future operations; setting-up the operating function of said “IRQ Logic” block appropriately with the help of said “IRQ Status/Config” block considering said voice activation algorithm to be actually implemented; processing continuously within said “Energy Processing” block e.g. said “Signal Energy Value” calculation, acting on said input signal named ‘Digital Audio Input Signal’; processing continuously within said “Noise Processing” block e.g. said “Noise Energy Value” estimation, which depends on its input signal, e.g. said already formerly calculated “Signal Energy Value”; processing continuously within said “Speech Estimation” block e.g. said “Speech Energy Value”, which depends on its input signal, e.g. said already formerly calculated “Signal Energy Value”; storing within its corresponding storing units located within module level two the results of said preceding “Amplitude Processing”, “Energy Processing”, “Noise Processing” and “Speech Processing” operations, namely said “Amplitude Value”, “Signal Energy Value”, “Noise Energy Value”, and “Speech Energy Value” all taken directly or indirectly from said ‘Digital Audio Input Signal’; setting-up within said storing units said respective threshold values named “Amplitude Threshold”, “Energy Threshold”, “Noise Threshold” and “Speech Threshold” corresponding to said actually chosen voice activation algorithm for future comparing operations; comparing with the help of said “Amplitude Comparator”, “Energy Comparator”, “Noise Comparator”, and “Speech Comparator” said “Amplitude Threshold” and “Amplitude Value”, said “Energy Threshold” and “Signal Energy Value”, said “Noise Threshold” and “Noise Energy Value”, as well as said “Speech Threshold” and “Speech Energy Value”; evaluating the outcome of the former comparing operations within said “IRQ Logic” block with respect to said earlier set-up operating function; generating, depending on said “IRQ Logic” evaluation in the case where applicable a trigger event as IRQ impulse signalling a recognized speech element for said voice activation; and re-starting again said once established operating scheme for said voice activation circuits system from said starting point above and continue its looping schedule.

Further in accordance with the objects of this invention, a circuit, implementing said new method is achieved, realizing a voice activation system capable of implementing multiple voice activation algorithms and being composed of four levels of building block modules as well as connection means, receiving an audio input signal and furnishing a trigger impulse as output signal, comprising an input terminal as entry for said audio input signal into a first level of modules; a first level of modules consisting of a set of processing modules including modules for signal amplitude preparation, energy calculation and especially noise and speech estimation; a second level of modules consisting of a set of intermediate storage modules for threshold and signal values; a multipurpose connection means in order to transfer said audio input signal to said first level modules and to appropriately connect said first level modules to each other and to said second level of modules; a third level of modules consisting of comparator modules; a fourth level of modules as trigger generating means including additional configuration, setup and logic modules; and an output terminal for said IRQ signal as said output signal in form of said trigger impulse.

### BRIEF DESCRIPTION OF THE DRAWINGS

In the accompanying drawings forming a material part of this description, the details of the invention are shown:

FIG. 1A shows the electrical block diagram for the essential part of the new system and circuit as the preferred embodiment of the present invention i.e. a block diagram for the complete tailorable structure of circuit modules and implementable with a variety of modern monolithic integrated circuit technologies.

FIGS. 1B-1F show in form of a flow diagram the according method for operating said tailorable module structure as shown in FIG. 1A.

FIG. 1G depicts a general block diagram for a general structure of building blocks module suitable as tailorable and adaptable voice activation circuit.

FIGS. 1H-1L show in form of a flow diagram the according generalized method for operating said general module structure as shown in FIG. 1G.

FIG. 2 depicts an example of frequency response diagrams, in form of a so called ‘Modulated White Noise’ diagram for voice activation algorithms.

FIG. 3 depicts the frequency response diagram in form of a ‘Modulated White Noise’ diagram for said voice activation algorithm named ALGO1 (see below).

FIG. 4 depicts the frequency response diagram in form of a ‘Modulated White Noise’ diagram for said voice activation algorithm named ALGO2 (see below).

FIG. 5 depicts the frequency response diagram in form of a ‘Modulated White Noise’ diagram for said voice activation algorithm named ALGO3 (see below).

FIG. 6 depicts the frequency response diagram in form of a ‘Modulated White Noise’ diagram for said voice activation algorithm named ALGO4 (see below).

### DESCRIPTION OF THE PREFERRED EMBODIMENTS

The preferred embodiments disclose a novel optimized circuit with a modules conception for a speech detection and voice activation system using modern integrated circuits and an exemplary implementation thereto.

As already stated above speech detection procedures do have to be adapted to all the possible environmental and operational situations in such a way, that always the most apt procedures i.e. algorithms and their optimum parameters are chosen, as no unique procedure on its own is capable of fulfilling all the desired requirements under all conditions. Therefore it is suitable to answer certain relevant questions about the audio signal itself, about the environment, about technical and manufacturing aspects as re-listed in the following:
Is the audio signal loudness high or low in comparison to background noise?

This question is the base for the algorithm. If the signal, which has to be detected, is loud in comparison to the background noises, the used algorithm can be very simple. Unfortunately, in most cases the background noises can be often very loud and the application has to cope with it. If the background noise is low however, only the signal amplitude or the signal energy value can be used.
Is the audio signal consisting of speech, baby sounds or artificial sound?

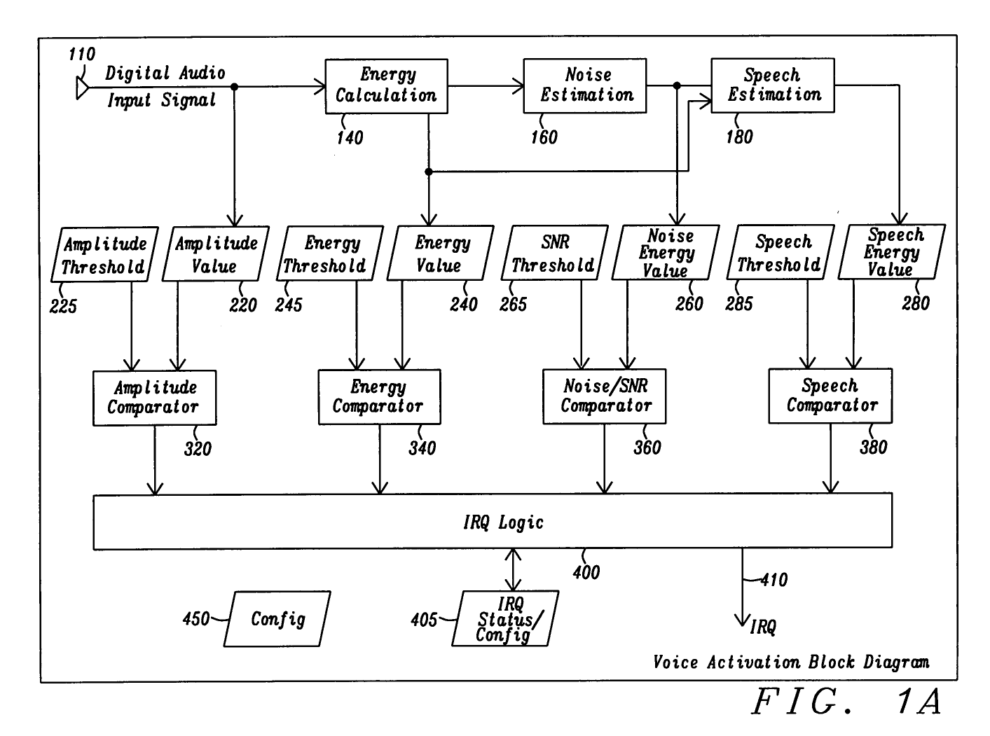

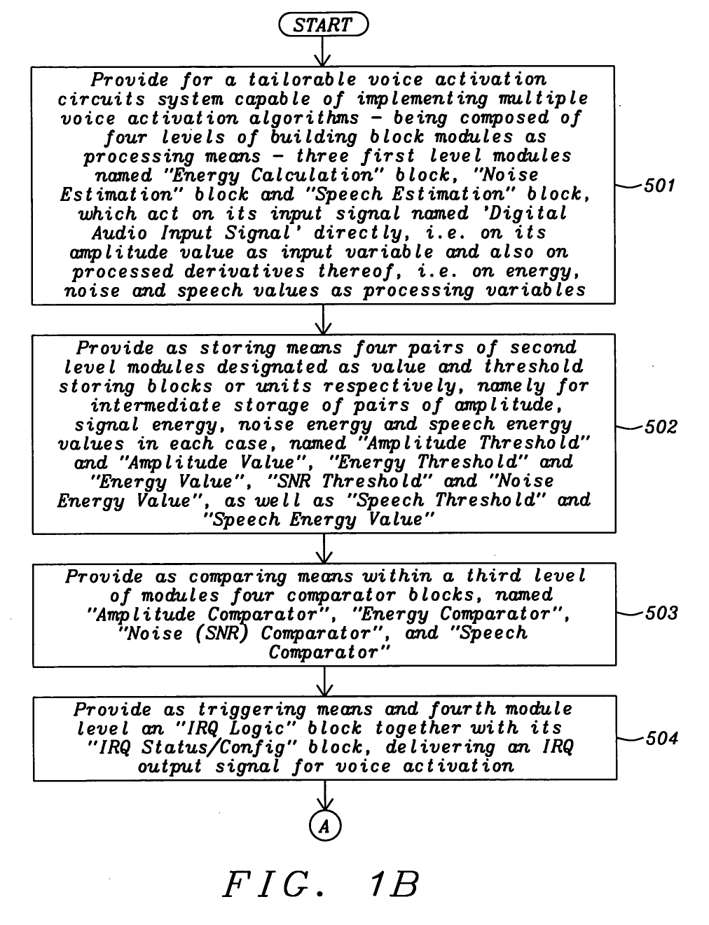

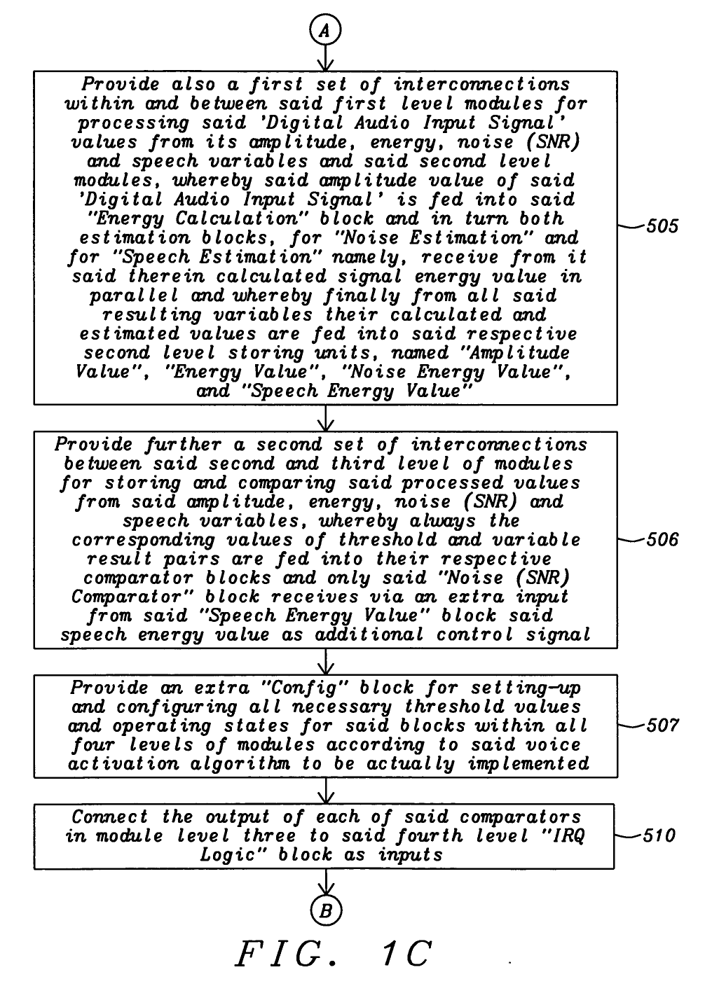

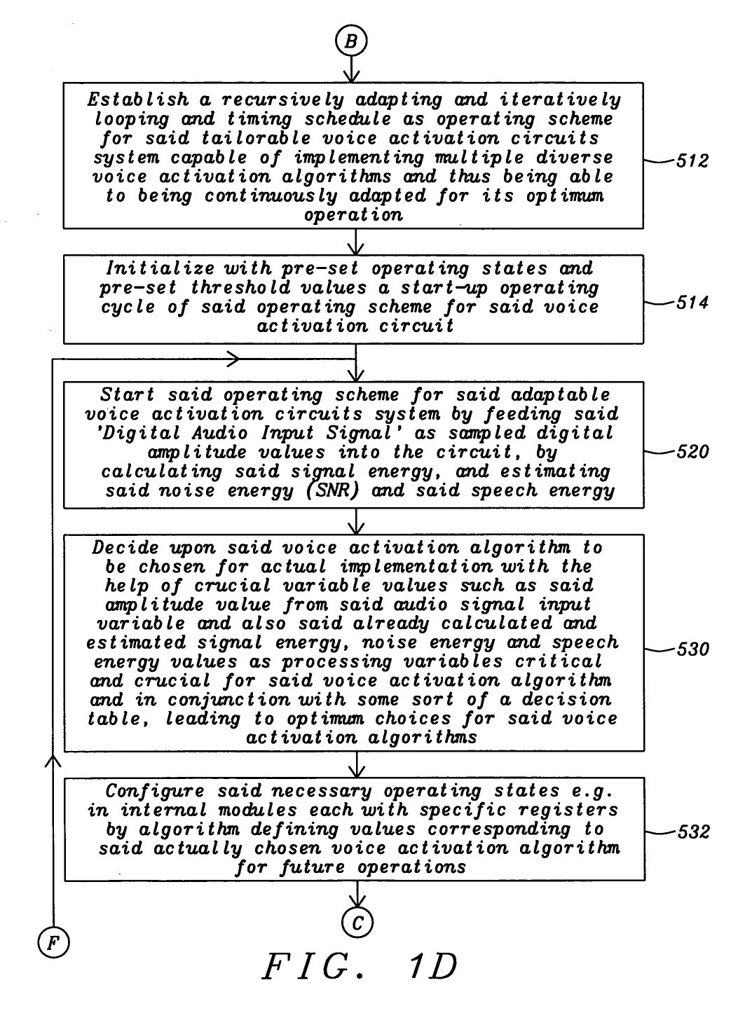

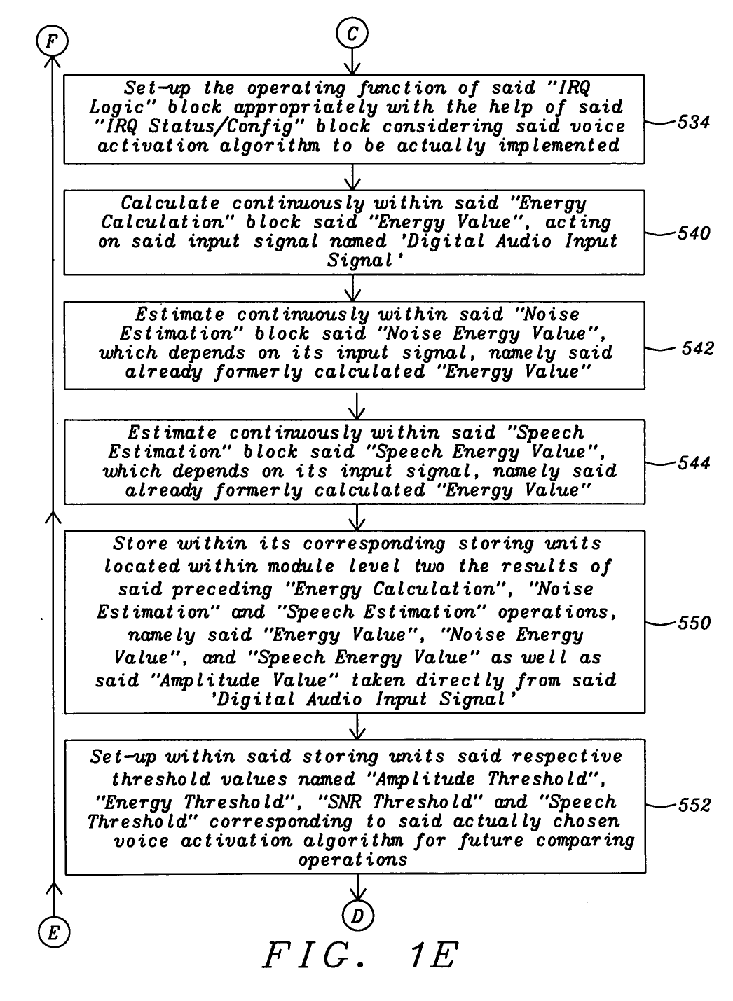

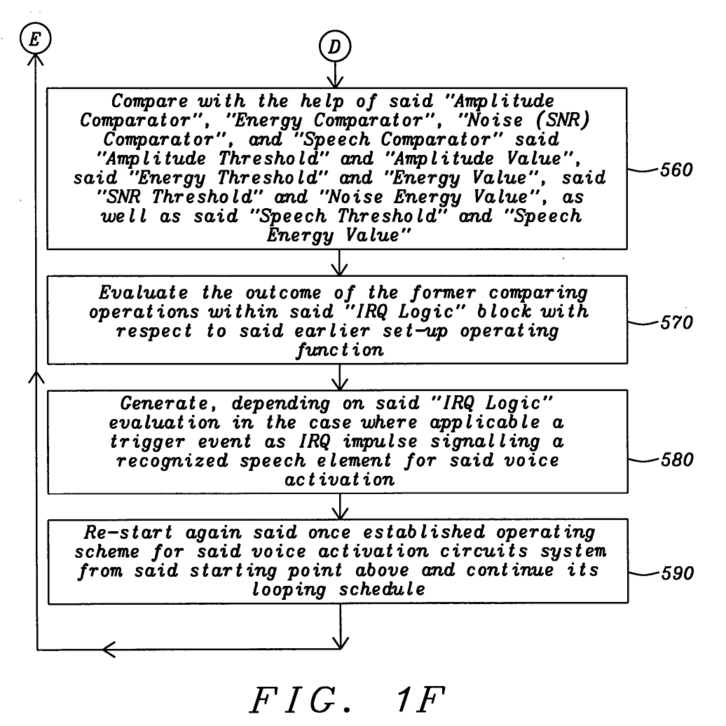

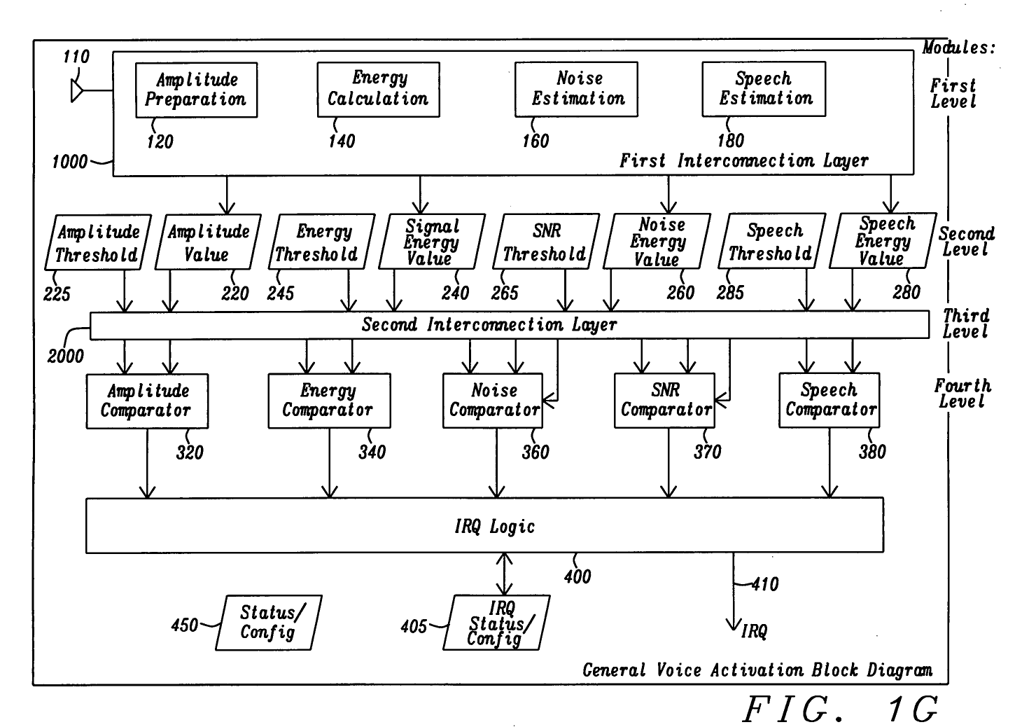

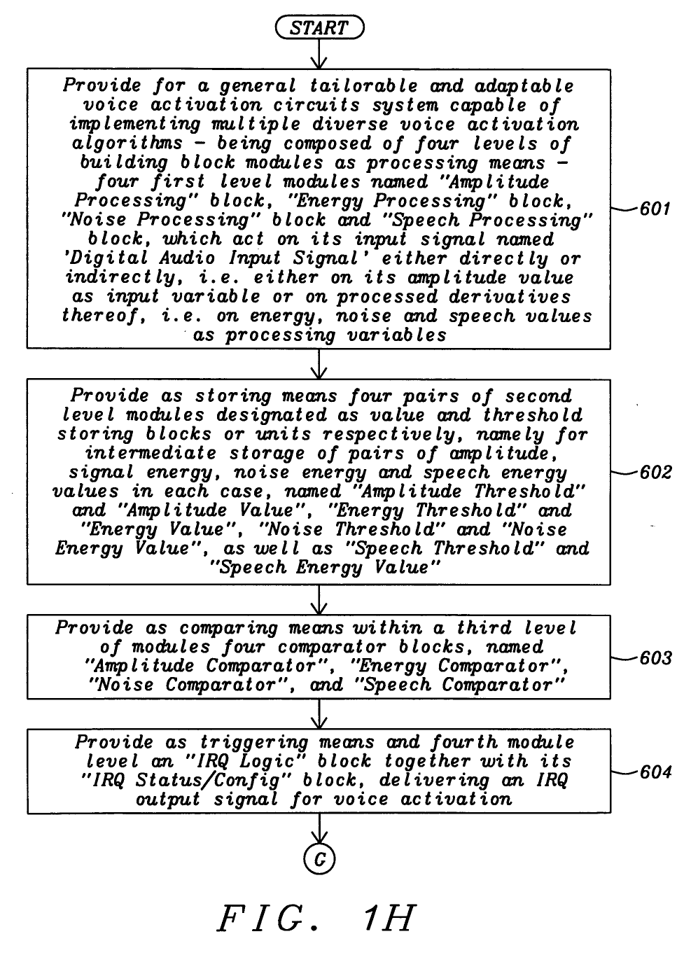

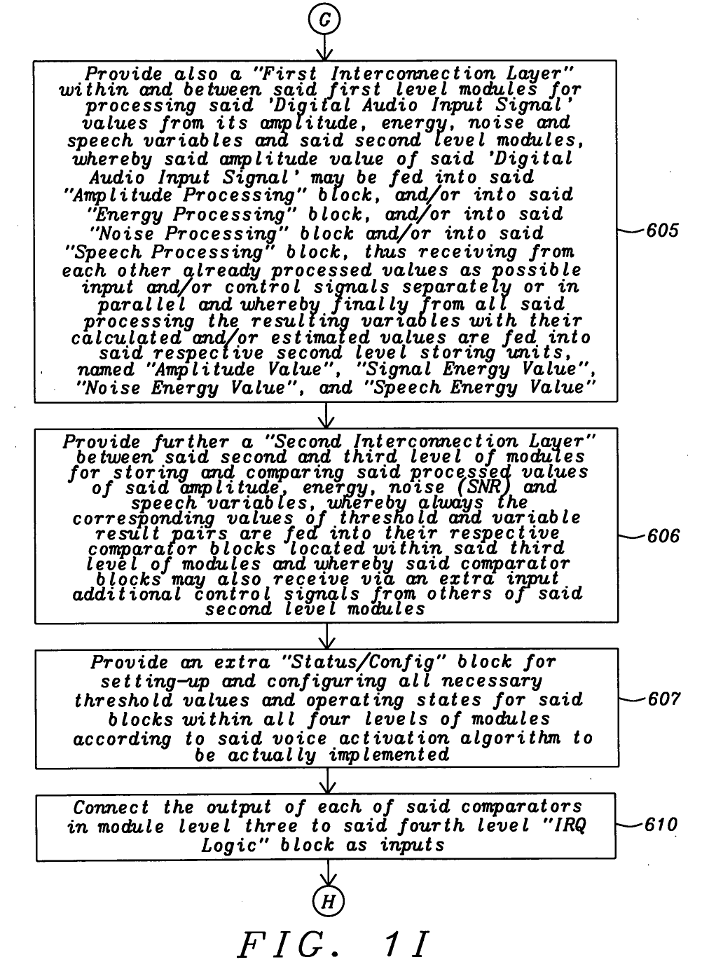

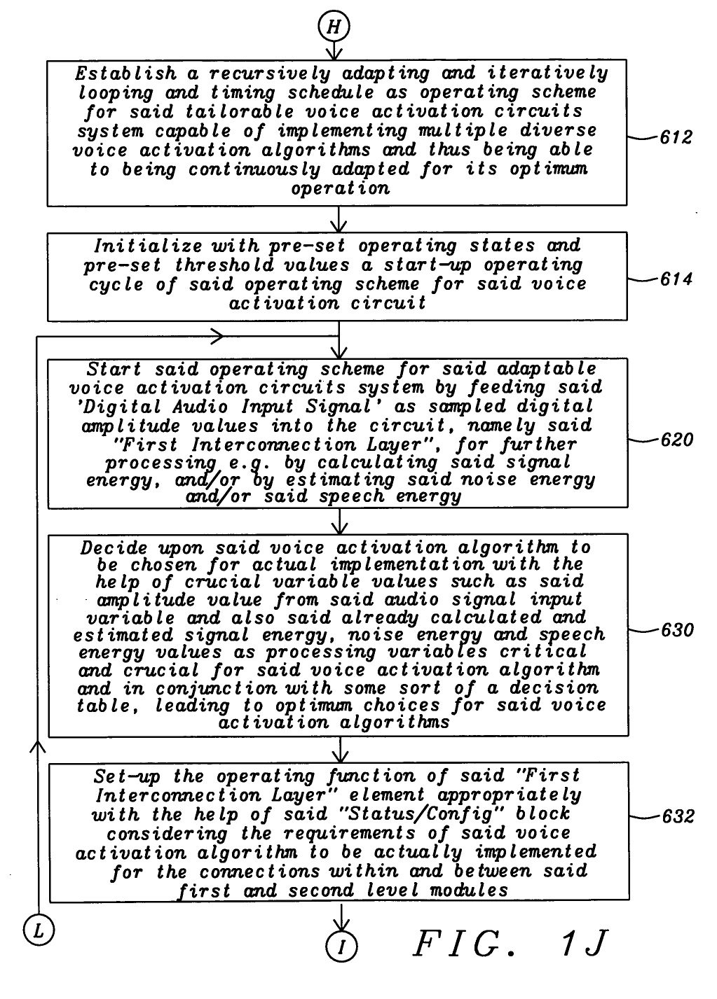

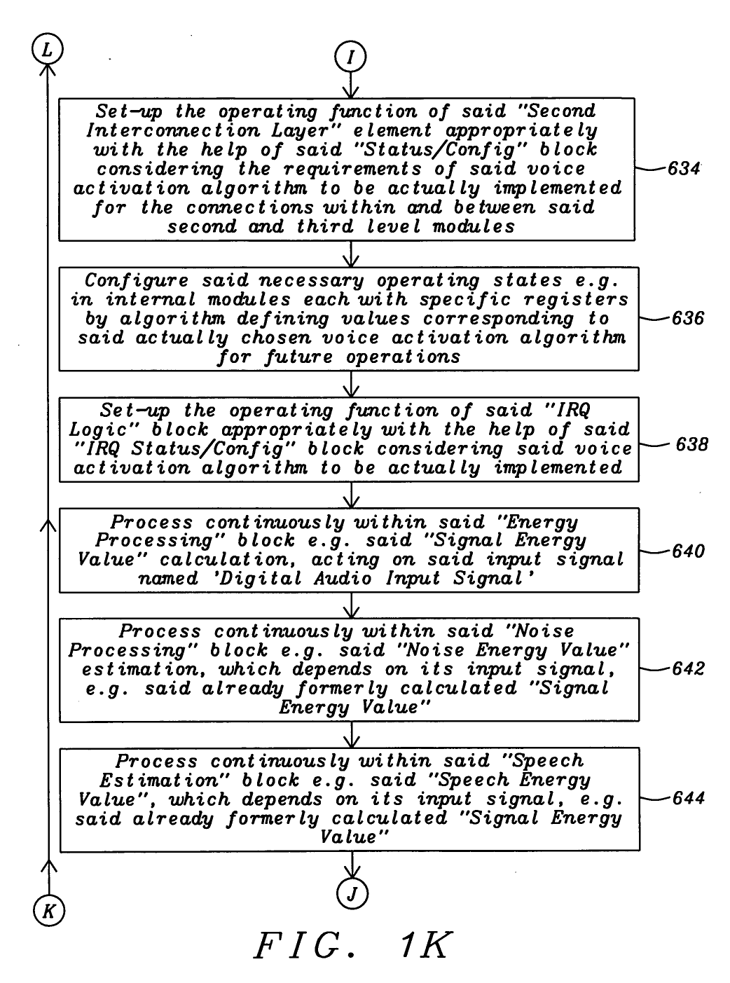

If the algorithm has to handle loud background noises, it would be good to know more about the sound signal. If it is a speech signal, special characteristics of the speech can be used to differentiate between the activation signal and the background noise. In the case of baby sounds, the voice activation can use characteristics from baby sounds. If the activation sound is artificial, the algorithm can be adapted to this special sound. This is however only really useful for speech or baby sounds. For other especially artificial sounds only the amplitude or energy values should be used.
Is the environment a quiet one, or one with a constant background noise level or even with a changing background noise level?
   The main point of this question is, if the background noises are changing, the algorithm has to be adaptive to the background noises, i.e. a noise estimation is needed. Fixed thresholds without any adaptations are inefficient for this environment. In the case of a constant background noise level one can estimate the signal energy using amplitude values only, together with an energy calculation, using concurrently stored energy calculation results.
Is the application to be used in a room, such as a church e.g. (question of reverberation) or outdoors?
   Reverberation is the main factor for activation failures, because the sound energy is not attenuated fast enough and the sound characteristic of speech will be changed. In small rooms or outdoors the reverberation is normally no problem, but in rooms like churches the reverberation has an impact on the algorithm. Hereby the noise estimation parameters have to be adapted, for example with the help of low-pass filtering techniques.
Are one or more microphones used for signal pick-up?
   If there is more than one microphone, the signal can be enhanced by calculating the direction of the sound source. This can be used in cases where the direction of the voice is known. (Not evaluated herein.) To be mentioned is, in case of more microphones only amplitude and energy calculation methods are needed, due to the clearer voice reception.
Is the microphone positioned near to or far away from the mouth of the speaker?
   If the microphone is neβar to the mouth (in case of voice activation) the Signal to Noise Ratio (SNR) is normally very high. If the microphone is far away from the signal source, background noises could be in the range of the voice energies. An reliable activation can be very difficult then.
Is the microphone, amplifier and codec depending on or adjusted to the user?
   If every user uses different microphones, amplifier or codecs, the voice activation algorithm has to be adaptive. This is sometimes very difficult, if the algorithm has no measurable parameters for that purpose. If the user can adjust the amplifiers however, the thresholds have also to be adjusted.
Is the microphone amplification manually adjustable by the user or automatically?
   A similar point is, if the user is able to adjust the amplification of the microphone, or if there is an automatic gain control in the application, the algorithm has to be adaptive to the gain. The same as above is holding also for the thresholds.
Are short reaction times a desired feature?
   If the voice activation is used as a trigger point for voice recognition, the reaction time of the voice activation has to be in the range of some few milliseconds. Some of the algorithms (especially the more reliable ones) have finite reaction times.
How important is the reliability of the activation and/or are only very few classification errors allowed?
   In some applications a high reliability of the activation is needed, that means, if there is an activation signal, the algorithm should sign the activation. Additionally the algorithm should have very few classification errors, which means that if there is no activation signal, the algorithm should not sign an activation. Sometimes a simple algorithm can be chosen and a post processing decides about a reliable activation, when reaction times are not that important. Looking into FIG. 1G one can determine an increase of reliability from left to right, i.e. considering the modules participating in an implementation of the algorithms used.
Which importance do power consumption, necessary chip area, production price and project time schedule for the realization have?
   Because power consumption, chip area, production price and project time schedule are normally important, the algorithm should be the simplest one capable to handle the voice activation in the specific application and environment.

After carefully considering and evaluating the answers given to such questions—whereby that list above may be expanded and amended in many ways—a choice has to be made out of a pool of voice activation algorithms for the specific application. One question to be answered hereby is who, where and when makes this choice? It can either be made during design i.e. statically before operation. Or it can be done by the user dynamically responding during a configuration phase. Both ways of working are possible.

Then this choice of algorithms has to be adequately implemented in the most efficient and economical way. Therefore, now referring to FIG. 1A, the essential part of this invention in form of a modular circuit for a reliable voice activation system is presented, capable for being manufactured with modern monolithic integrated circuit technologies. Said voice activation system consists of a microphone for audio signal pick-up, a microphone amplifier, and an Analog-to-Digital (AD) converter—often realized as external components—and the actual voice activation circuit device, using a modular building block approach as drawn in FIG. 1A.

What shall be especially emphasized here is the introduction of two separate and specific blocks for “Noise Estimation” and “Speech Estimation” in combination with “Amplitude Preparation” and “Energy Calculation” and their corresponding threshold triggering operations as main parts of this invention.

Said building blocks are adaptively tailored to handle certain relevant and well known case specific operational characteristics describing the acoustical differing cases analyzed by such a list of questions as collocated above and leading to said choice of algorithms. Said algorithms are then realized and activated by tailoring said building blocks within said actual voice activation circuit device according to the method of this invention, explained and described with the help of a flow diagram given later in FIGS. 1B-1F.

In the following the introduction of two so called “interconnection layers” is explained, expanding the structure of FIG. 1A, thus leading to a new structure shown in FIG. 1G and thus generalizing the building block idea by allowing for an addition of new interconnections between existing modules or even omitting old interconnections from those modules. This has the further advantage to enable realizing of upcoming new algorithms in future with exactly this same general structure, making such new and additionally necessitated interconnections already and easily feasible.

The block diagram in FIG. 1G however depicts an even more general module structure for a voice activation module circuit with only very general construction elements, such as four levels of modules as tailorable processing, storing, comparing and triggering means and two internal interconnection layers located between them where appropriate and functioning as tailorable connection means. This general module circuit provides therefore all the means necessary to calculate inter alia the actual signal energy and to differentiate between speech energy and noise energy. Thresholds can be set on the amplitude values, the signal energy, the speech energy and on the Signal to Noise Ratio (SNR) in order to perform the desired voice activation function.

Studying FIGS. 1H-IL the generalized method according to this more general module structure of FIG. 1G is explained and described with the help of a comparable flow diagram.

Delving now into FIG. 1A an entry 110 for the ‘Digital Audio Input Signal’ into the first level of modules is recognized. Said signal is further transferred via a multipurpose connection means 100, such as dedicated signal wires or a bus system e.g. to three first level main modules, namely an “Energy Calculation” module 140, a “Noise Estimation” module 160 and a “Speech Estimation” module 180. On a second level of modules a set of intermediate storage modules is situated, namely an “Amplitude Value” item 220 with adjacent “Amplitude Threshold” item 225, an “Energy Value” item 240 with adjacent “Energy Threshold” item 245, a “Noise Energy Value” item 260 with adjacent “SNR Threshold” item 265, and finally a “Speech Energy Value” item 280 with adjacent “Speech Threshold” item 285. A third level of modules is formed out of four comparator modules with both threshold and signal value inputs as well as an extra control input, each comparing the outcoming corresponding value pairs for amplitudes, energies, noise and speech, all parametrizable by respective control signals made available from said second level modules; namely first an “Amplitude Comparator” module 320, second an “Energy Comparator” module 340, third an “SNR Comparator” module 360 and fourth a “Speech Comparator” module 380. The signal outputs of said latter four comparator modules are all entering an Interrupt ReQuest signal generating “IRQ Logic” module 400, accompanied by an “IRQ Status/Config” module 405, delivering said wanted IRQ signal 410, signalling a recognized event for said wanted voice activation. In parallel to all these modules a “Config” module 450 is operating, handling all the necessary analysis functions, as well as all adaptation and configuration settings for pertaining modules in each case.

Contemplating now FIG. 1G a more general view over the structure of modules for a voice activation system is given. Said multipurpose connection means 100 from FIG. 1A may be generalized as a so called “First Interconnection Layer” 1000 for the tailorable connecting of inputs and outputs between first and second level modules. At first, said entry 110 for the ‘Digital Audio Input Signal’ now fed into said “First Interconnection Layer” item 1000 is recognized. Said signal is further transferred via said multipurpose connection means 1000 to several “First Level Modules” serving as general processing (calculating, estimating) means, namely an “Amplitude Processing” block e.g. an “Amplitude Preparation” module 120, an “Energy Processing” block e.g. an “Energy Calculation” module 140, a “Noise Processing” block e.g. a “Noise Estimation” module 160 and a “Speech Processing” block e.g. a “Speech Estimation” module 180. As “Second Level Modules”, serving as general storage means, a set of intermediate storage modules is provided, namely an “Amplitude Value” item 220 with adjacent “Amplitude Threshold” item 225, a “Signal Energy Value” item 240 with adjacent “Energy Threshold” item 245, a “Noise Energy Value” item 260 with adjacent “Noise Threshold” item 265, and finally a “Speech Energy Value” item 280 with adjacent “Speech Threshold” item 285. Said next level of modules is formed out of “Third Level Modules”, serving as general comparing means and consisting of four comparator modules with both threshold and signal value inputs as well as an extra control input, each comparing the outcoming corresponding value pairs for amplitudes, energies, noise and speech, all parametrizable by respective control signals made available from said “Second Level Modules”; namely first an “Amplitude Comparator” module 320, second an “Energy Comparator” module 340, third a “Noise Comparator” module 360 and fourth as module 370, realizing more complex mathematical functions here e.g. a “Signal-to-Noise Ratio (SNR) Calculator” module and fifth a “Speech Comparator” module 380. A so called “Second Interconnection Layer” 2000 provides connection means for the tailorable connecting of outputs and inputs of second and third level modules, thus allowing meaningfully interconnecting all relevant modules in each case. The signal outputs of said latter four comparator modules are all entering an Interrupt ReQuest signal generating “IRQ Logic” module 400, accompanied by an “IRQ Status/Config” module 405, delivering said wanted IRQ signal 410, signalling a recognized event for said wanted voice activation. These modules are then designated as “Fourth Level Modules”. In parallel to all these modules a “Config” module 450 is operating, handling all the necessary analysis functions, as well as all adaptation and configuration settings for pertaining modules in each case. On every level of modules a further inclusion of suitable additional modules is thinkable and may here already be suggested, surely also making necessary an according and appropriate expansion of each interconnection layer. Technology advances may allow much more complex analysis methods being available as dedicated circuit blocks in the future.

Before describing the particular methods according to FIG. 1A and according to FIG. 1G in some more detail the algorithms actually considered in this invention for voice activation purposes are explained. Basically and exemplary, and not limited to this choice and number—the following five algorithms are analyzed:
“Threshold Detection on Signal Amplitude” algorithm—ALGO1
“Automatic Threshold Adaptation on Background Noise” algorithm—ALGO2
“Threshold Detection on Signal Energy” algorithm—ALGO3
“Threshold Detection on Speech Energy” algorithm—ALGO4
“Signal to Noise Ratio (SNR)” algorithm—ALGO5

In the following some more detailed remarks to the interaction between said levels of main modules when implementing said voice activation algorithms are made, thus clarifying some of the underlying operating principles, which inversely in other words, could also be transformed into or deduced from every single description of the corresponding voice activation algorithms, whatever is appropriate.

Module 320, denominated as “Amplitude Comparator”, which compares the actual “Amplitude Value” 220—directly derived from said Digital Audio Input Signal 110—with the previously stored “Amplitude Threshold” 225 is the primary module for implementing a “Threshold Detection on Signal Amplitude” algorithm ALGO1, to be more explicitly described later. Whenever the “Amplitude Value” 220 exceeds the “Amplitude Threshold” 225 the “Amplitude Comparator” 320 signs this to the IRQ Logic 400. For the implementation of a “Threshold Detection on Signal Energy” algorithm ALGO3 said module 140 provides an “Energy Calculation” function, which is realized as e.g. an ordinary low pass filter on the absolute signal value or squared signal calculating the actual “Energy Value” 240. Said “Energy Comparator” 340 compares the actual “Energy Value” 240 with an “Energy Threshold” 245. If the “Energy Value” 240 exceeds the “Energy Threshold” 245 the “Energy Comparator” 340 signs this to the “IRQ Logic” 400. An “Automatic Threshold Adaptation on Background Noise” algorithm ALGO2 is implemented starting with module 160, which includes the “Noise Estimation” operation, which is realized by a minimum detection unit detecting the minimum of the energy in a moving window. This minimum is the estimation for the noise in the signal, termed as “Noise Energy Value” 260. The “SNR Comparator” 360 calculates from the actual “Noise Energy Value” 260 and the actual “Speech Energy Value” 280 the actual SNR and compares it with an “SNR Threshold” 265. If the SNR exceeds the “SNR Threshold” 265 the “SNR Comparator” 360 signs this to the “IRQ Logic” 400. The implementation of a “Threshold Detection on Speech Energy” algorithm ALGO4 includes module 180, which is described as the “Speech Estimation” unit which performs a subtraction of the “Noise Energy Value” 260 from the energy value stored in “Speech Energy Value” 280. The “Speech Comparator” 380 compares the “Speech Energy Value” 280 with a “Speech Threshold” 285 and signs the result to the IRQ Logic 400. A description for “SNR” algorithm ALGO5 has to include mentioning the use of all available modules in order to calculate the Signal-to-Noise Ratio (SNR), which is defined as the ratio of Speech energy to Noise energy, wherein the energy ‘E’ accumulated within a certain number ‘n’ of samples of digital amplitude values is generally calculated in digital signal processing systems from sampled digital Signal amplitude values ‘s(n)’ as ‘E’=[Sum of all ‘n’ values (‘s(n)’ times ‘s(n)’)] or using the much easier to implement procedure of Low-Pass (LP) filtering said (‘s(n)’ times ‘s(n)’) product, as it is done in said “Energy Calculation” block. The determination of the Signal-to-Noise Ratio (SNR) needs using the resulting energy values from said “Noise Estimation” block and said “Speech Estimation” block, whereby Speech is defined as the difference of Signal energy minus Noise energy.

Completing now, the IRQ Logic 400 can be configured in such a way, that one can select which type of voice activation should be used, whereby said voice activation algorithms as directly implemented or even boolean combinations of these algorithms can be set-up. As the circuit is already capable to evaluate all the described signal parameters it could be advantageous also to use said parameters to perform other auxiliary functions, e.g. using the feature noise estimation for the control of a speaker volume.

A first method, belonging to the block diagram of FIG. 1A is now described and its steps explained according to the flow diagram given in FIGS. 1B-1F, where the first step 501 provides for a tailorable voice activation circuits system capable of implementing multiple voice activation algorithms—being composed of four levels of building block modules as processing means—three first level modules named “Energy Calculation” block, “Noise Estimation” block and “Speech Estimation” block, which act on its input signal named ‘Digital Audio Input Signal’ directly, i.e. on its amplitude value as input variable and also on processed derivatives thereof, i.e. on energy, noise and speech values as processing variables, where the second step 502 provides as storing means four pairs of second level modules designated as value and threshold storing blocks or units respectively, namely for intermediate storage of pairs of amplitude, signal energy, noise energy and speech energy values in each case, named “Amplitude Threshold” and “Amplitude Value”, “Energy Threshold” and “Energy Value”, “SNR Threshold” and “Noise Energy Value”, as well as “Speech Threshold” and “Speech Energy Value”, where the third step 503 provides as comparing means within a third level of modules four comparator blocks, named “Amplitude Comparator”, “Energy Comparator”, “Noise (SNR) Comparator”, and “Speech Comparator” and where the fourth step 504 provides as triggering means and fourth module level an “IRQ Logic” block together with its “IRQ Status/Config” block, delivering an IRQ output signal for voice activation. The following two steps, 505 and 506, provide a first set of interconnections within and between said first level modules for processing said ‘Digital Audio Input Signal’ values from its amplitude, energy, noise (SNR) and speech variables and said second level modules, whereby said amplitude value of said ‘Digital Audio Input Signal’ is fed into said “Energy Calculation” block and in turn both estimation blocks, for “Noise Estimation” and for “Speech Estimation” namely, receive from it said therein calculated signal energy value in parallel and whereby finally from all said resulting variables their calculated and estimated values are fed into said respective second level storing units, named “Amplitude Value”, “Energy Value”, “Noise Energy Value”, and “Speech Energy Value” and also provide a second set of interconnections between said second and third level of modules for storing and comparing said processed values from said amplitude, energy, noise (SNR) and speech variables, whereby always the corresponding values of threshold and variable result pairs are fed into their respective comparator blocks and only said “Noise (SNR) Comparator” block receives via an extra input from said “Speech Energy Value” block said speech energy value as additional control signal. Finally step 507 provides an extra “Config” block for setting-up and configuring all necessary threshold values and operating states for said blocks within all four levels of modules according to said voice activation algorithm to be actually implemented. With step 510 of the method the output of each of said comparators in module level three is connected to said fourth level “IRQ Logic” block as inputs, step 512 establishes a recursively adapting and iteratively looping and timing schedule as operating scheme for said tailorable voice activation circuits system capable of implementing multiple diverse voice activation algorithms and thus being able to being continuously adapted for its optimum operation and step 514 initializes with pre-set operating states and pre-set threshold values a start-up operating cycle of said operating scheme for said voice activation circuit.

The method continues with step 520 starting said operating scheme for said adaptable voice activation circuits system by feeding said ‘Digital Audio Input Signal’ as sampled digital amplitude values into the circuit, and by calculating said signal energy within said “Energy Calculation” block, and estimating said noise energy (also used for SNR determination) and said speech energy within said “Noise Estimation” block and said “Speech Estimation” block; then step 530 decides upon said voice activation algorithm to be chosen for actual implementation with the help of crucial variable values such as said amplitude value from said audio signal input variable and also said already calculated and estimated signal energy, noise energy and speech energy values as processing variables critical and crucial for said voice activation algorithm and in conjunction with some sort of decision table, leading to optimum choices for said voice activation algorithms. It shall be emphasized here, that within steps 520 & 530 said “Noise estimation and “Speech estimation” can be done effectively without use of Fast Fourier Transform (FFT) methods or zero crossing algorithms only by analyzing the modulation properties of human voice.

Two more steps, 532 and 534, are needed to configure said necessary operating states e.g. in internal modules each with specific registers by algorithm defining values corresponding to said actually chosen voice activation algorithm for future operations and to set-up the operating function of said “IRQ Logic” block appropriately with the help of said “IRQ Status/Config” block considering said voice activation algorithm to be actually implemented. The method now calculates continuously within said “Energy Calculation” block said “Energy Value”, acting on said input signal named ‘Digital Audio Input Signal’ in step 540, in steps 542 and 544 estimates continuously within said “Noise Estimation” block said “Noise Energy Value”, and within said “Speech Estimation” block said “Speech Energy Value”, which both depend on that input signal, namely said already formerly in step 540 calculated “Energy Value”. Step 550 then stores within its corresponding storing units located within module level two the results of said preceding “Energy Calculation”, “Noise Estimation” and “Speech Estimation” operations, namely said “Energy Value”, “Noise Energy Value”, and “Speech Energy Value” as well as said “Amplitude Value” taken directly from said ‘Digital Audio Input Signal’. It is now in step 552, the method sets-up within said storing units said respective threshold values named “Amplitude Threshold”, “Energy Threshold”, “SNR Threshold” and “Speech Threshold” corresponding to said actually chosen voice activation algorithm for future comparing operations before step 560 compares with the help of said “Amplitude Comparator”, “Energy Comparator”, “Noise (SNR) Comparator”, and “Speech Comparator” said “Amplitude Threshold” and “Amplitude Value”, said “Energy Threshold” and “Energy Value”, said “SNR Threshold” and “Noise Energy Value”, as well as said “Speech Threshold” and “Speech Energy Value”. Coming near the end of the method, step 570 evaluates the outcome of the former comparing operations within said “IRQ Logic” block with respect to said earlier set-up operating function and generates in step 580, depending on said “IRQ Logic” evaluation in the case where applicable a trigger event as IRQ impulse signalling a recognized speech element for said voice activation. Finally step 590 serves to re-start again said once established operating scheme for said voice activation circuits system from said starting point above and continue its looping schedule.

This concludes the description of the first method belonging to the structure of FIG. 1A, a second, more general method, belonging to the general block diagram shown in FIG. 1G is now explained according to the comparable flow diagram of FIGS. 1H-1L, where the first step 601 provides for a general tailorable and adaptable voice activation circuits system capable of implementing multiple diverse voice activation algorithms—being composed of four levels of building block modules as processing means—four first level modules named “Amplitude Processing” block, “Energy Processing” block, “Noise Processing” block and “Speech Processing” block, which act on its input signal named ‘Digital Audio Input Signal’ either directly or indirectly, i.e. either on its amplitude value as input variable or on processed derivatives thereof, i.e. on energy, noise and speech values as processing variables, where the second step 602 provides as storing means four pairs of second level modules designated as value and threshold storing blocks or units respectively, namely for intermediate storage of pairs of amplitude, signal energy, noise energy and speech energy values in each case, named “Amplitude Threshold” and “Amplitude Value”, “Energy Threshold” and “Energy Value”, “Noise Threshold” and “Noise Energy Value”, as well as “Speech Threshold” and “Speech Energy Value”, where the third step 603 provides as comparing means within a third level of modules four comparator blocks, named “Amplitude Comparator”, “Energy Comparator”, “Noise Comparator”, and “Speech Comparator”, and where the fourth step 604 provides as triggering means and fourth module level an “IRQ Logic” block together with its “IRQ Status/Config” block, delivering an IRQ output signal for voice activation. The next two steps 605 and 606 further provide a “First Interconnection Layer” within and between said first level modules for processing said ‘Digital Audio Input Signal’ values from its amplitude, energy, noise and speech variables and said second level modules, whereby said amplitude value of said ‘Digital Audio Input Signal’ may be fed into said “Amplitude Processing” block, and/or into said “Energy Processing” block, and/or into said “Noise Processing” block and/or into said “Speech Processing” block, thus receiving from each other already processed values as possible input and/or control signals separately or in parallel and whereby finally from all said processing the resulting variables with their calculated and/or estimated values are fed into said respective second level storing units, named “Amplitude Value”, “Signal Energy Value”, “Noise Energy Value”, and “Speech Energy Value” and provide a “Second Interconnection Layer” between said second and third level of modules for storing and comparing said processed values of said amplitude, energy, noise, SNR-value and speech variables, whereby always the corresponding values of threshold and variable result pairs are fed into their respective comparator blocks located within said third level of modules and whereby said comparator blocks may also receive via an extra input additional control signals from others of said second level modules. The following step 607 provides an extra “Status/Config” block for setting-up and configuring all necessary threshold values and operating states for said blocks within all four levels of modules according to said voice activation algorithm to be actually implemented. With step 610 of the method the output of each of said comparators in module level three is connected to said fourth level “IRQ Logic” block as inputs, step 612 establishes a recursively adapting and iteratively looping and timing schedule as operating scheme for said tailorable voice activation circuits system capable of implementing multiple diverse voice activation algorithms and thus being able to being continuously adapted for its optimum operation and step 614 initializes with pre-set operating states and pre-set threshold values a start-up operating cycle of said operating scheme for said voice activation circuit.

The method continues with step 620 starting said operating scheme for said adaptable voice activation circuits system by feeding said ‘Digital Audio Input Signal’ as sampled digital amplitude values into the circuit, namely said “First Interconnection Layer”, for further processing e.g. by calculating said signal energy, and/or by estimating said noise energy and/or said speech energy; then step 630 decides upon said voice activation algorithm to be chosen for actual implementation with the help of crucial variable values such as said amplitude value from said audio signal input variable and also said already calculated and estimated signal energy, noise energy and speech energy values as processing variables critical and crucial for said voice activation algorithm and in conjunction with some sort of a decision table, leading to optimum choices for said voice activation algorithms. Two steps, 632 and 634, are needed to set-up the operating function of said “First Interconnection Layer” element appropriately with the help of said “Status/Config” block considering the requirements of said voice activation algorithm to be actually implemented for the connections within and between said first and second level modules and to set-up the operating function of said “Second Interconnection Layer” element appropriately with the help of said “Status/Config” block considering the requirements of said voice activation algorithm to be actually implemented for the connections within and between said second and third level modules. Two more steps, 636 and 638, are needed to further configure said necessary operating states e.g. in internal modules each with specific registers by algorithm defining values corresponding to said actually chosen voice activation algorithm for future operations and to set-up the operating function of said “IRQ Logic” block appropriately with the help of said “IRQ Status/Config” block considering said voice activation algorithm to be actually implemented. The method now processes continuously in the following steps—640, 642 and 644—within said “Energy Processing” block e.g. said “Signal Energy Value” calculation, acting on said input signal named ‘Digital Audio Input Signal’ and within said “Noise Processing” block e.g. said “Noise Energy Value” estimation, and within said “Speech Estimation” block e.g. said “Speech Energy Value”, which both depend on that input signal, e.g. said already formerly in step 640 calculated “Signal Energy Value”. Step 650 then stores within its corresponding storing units located within module level two the results of said preceding “Amplitude Processing”, “Energy Processing”, “Noise Processing” and “Speech Processing” operations, namely said “Amplitude Value”, “Signal Energy Value”, “Noise Energy Value”, and “Speech Energy Value” all taken directly or indirectly from said ‘Digital Audio Input Signal’. It is now in step 652, the method sets-up within said storing units said respective threshold values named “Amplitude Threshold”, “Energy Threshold”, “Noise Threshold” and “Speech Threshold” corresponding to said actually chosen voice activation algorithm for future comparing operations before step 660 compares with the help of said “Amplitude Comparator”, “Energy Comparator”, “Noise Comparator”, “SNR Comparator”, and “Speech Comparator” said “Amplitude Threshold” and “Amplitude Value”, said “Energy Threshold” and “Signal Energy Value”, said “Noise Threshold” and “Noise Energy Value”, as well as said “Speech Threshold” and “Speech Energy Value”. Coming now near the end of the method, step 670 evaluates the outcome of the former comparing operations within said “IRQ Logic” block with respect to said earlier set-up operating function and generates in step 680, depending on said “IRQ Logic” evaluation in the case where applicable a trigger event as IRQ impulse signalling a recognized speech element for said voice activation. Finally step 690 serves to re-start again said once established operating scheme for said voice activation circuits system from said starting point above and continue its looping schedule.

In the next paragraph said different voice activation algorithms are described in more detail, the implementations of which are covered by the voice activation module circuit shown with the help of the block diagram in FIG. 1A and the specific realization of a certain algorithm is then achieved with the help of respectively tailored block diagrams, which means that all necessary combinations of calculation blocks such as “Energy Calculation” block, “Noise Estimation” block, and “Speech Estimation” block as well as their respective threshold determining and triggering blocks are appropriately combined, and together with their alloted “Comparator” blocks arranged into generating an adequate triggering signal within the “Interrupt Request (IRQ) Logic” block, when a voice activation according to said certain algorithm shall occur. A comparison thereby is made in a manner that, if the respective physical value e.g. the “Signal Amplitude” exceeds its stored threshold value, the according comparator e.g. “Amplitude Comparator” activates a signal which is then fed into the IRQ logic, wherein all combinations of all the detecting blocks and comparators can be logically combined for generating said triggering or detection signal according to the characteristic of said certain algorithm.

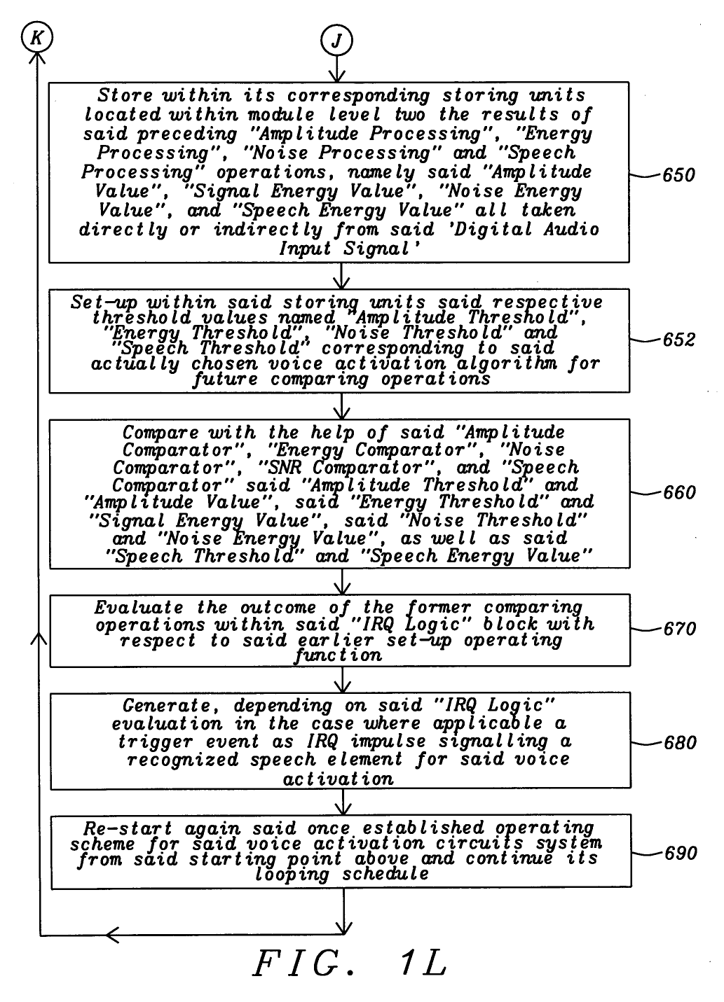

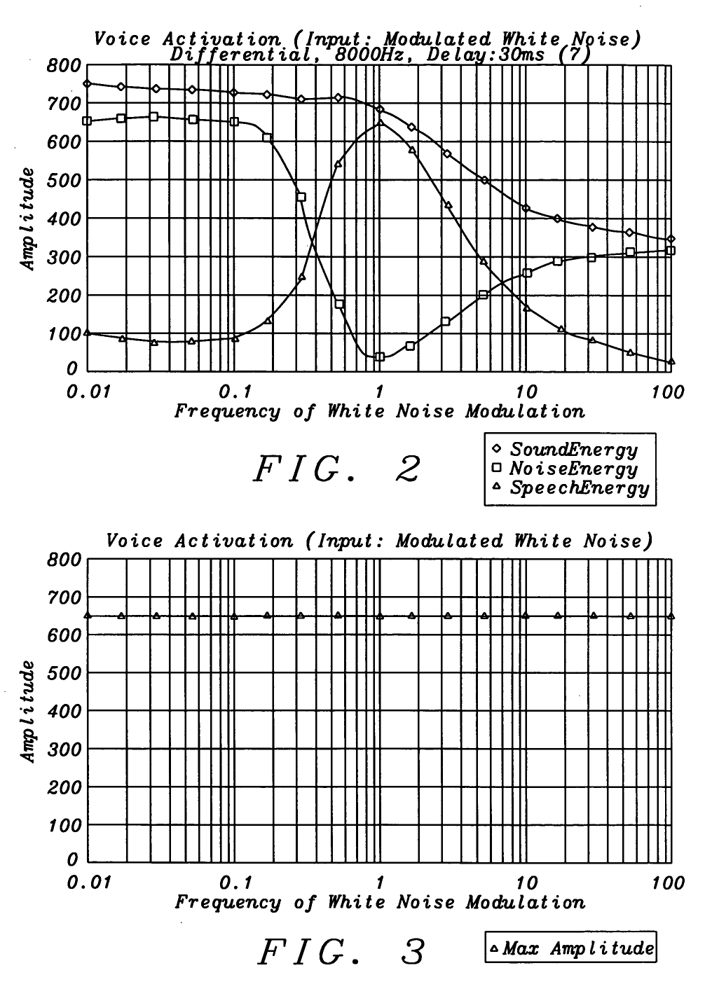

As introduction however, explaining a method to discriminate between the different voice activation algorithms, some words about experimental testing and theoretical analysis procedures and the presentation of its results have to be premised. When looking at FIG. 2, showing in form of a frequency response diagram a so called “White Noise Modulation Diagram for Sound Energy, Noise Energy and Speech Energy” as presentation of such results there can be seen: three curves for measured or calculated energies (Sound Energy, Noise Energy, and Speech Energy) drawn as Amplitudes over ‘Frequency of White Noise Modulation’ and titled as ‘Voice Activation (Input: ‘Modulated White Noise’)’ diagram. For a detailed description of the voice activation algorithms and a meaningful discrimination between them it is necessary to understand the behavior of each algorithm. Therefore, a model for different background noises is used to demonstrate the effectiveness of the algorithm. Said model of different background noises could be white noise, which is sinusoidally modulated in the range of 0.01 Hz to 100 Hz in the amplitude by 100%. This model simulates different sounds, which should be detected or should be ignored by the algorithm. It simulates for example background noises like a jackhammer (>10 Hz) or the slowly changing noise of cars driving on a road nearby. It also simulates speech, which modulates in the range of 1 Hz, which is understandable by the fact, that speech consists of phonemes and syllables with occlusives or plosives at least once a second, and that you have to breathe when talking. At these short moments, no sound energy is coming out of the mouth and therefore the sound energy for speech is modulated. This fact can be used to enhance the sound activation algorithms. Considering the curves of FIG. 2, the “Speech Energy” curve is calculated as difference, substracting the “Noise Energy” from the “Sound Energy”. These three curves are the result of a test with a voice activation algorithm, e.g. said “Threshold Detection on Speech Energy” algorithm ALGO4, where its implementation is operating on these three energies and said implementation being fed by said ‘Modulated White Noise’ as test input signal, said result delivered as output. Although the maximum input amplitude is the same for each modulation frequency in the range of 0.01 and 100 Hz, the estimated speech energy output is only high at 1 Hz. The sounds <0.2 Hz and >10 Hz are classified as noise and attenuated. The attenuation of the noise signal outside the speech modulation frequencies is more than 15 dB. Using comparable examinations in the following several algorithms are discussed and analyzed. The complexity of each algorithm varies from a simple analog comparator circuit up to a complex circuit with energy calculation for noise and speech estimation circuits. To prove the effectiveness of the algorithms individual diagrams similar to this one in FIG. 2 are made as ‘White Noise Modulation’ diagrams for each algorithm and depicted in the according diagrams FIGS. 3-6.

The algorithms considered here for voice activation purposes are basically the already known five algorithms ALGO1 to ALGO5, namely said “Threshold Detection on Signal Amplitude” algorithm—ALGO1; said “Automatic Threshold Adaptation on Background Noise” algorithm—ALGO2; said “Threshold Detection on Signal Energy” algorithm—ALGO3; said “Threshold Detection on Speech Energy” algorithm—ALGO4; and said “Signal to Noise Ratio (SNR)” algorithm—ALGO5 and now thoroughly explained:

“Threshold Detection on Signal Amplitude” Algorithm ALGOL:

The signal amplitude includes all sound information coming from the microphone limited only by the frequency characteristic of the microphone and the amplifiers. A threshold is used to determine, if a sound is loud enough to sign activation. Although “is loud enough” normally means the energy is high enough, the amplitude gives a more or less good substitution to the normally used energy. But there are some exceptions: there might be a high amplitude value although there is only very limited energy in the signal; the worst case would be a delta peak. On the other hand there might be a high energy, but overall a very small amplitude. In these special cases the amplitude would not show the loudness of the signal. The ‘Modulated White Noise’ diagram in FIG. 3 shows, that this algorithm detects the whole range of sounds and therefore can be used for the detection of artificial sounds too. Nevertheless, this algorithm (ALGOL) has the advantage to react very fast on high amplitudes. It is used, if SNR is large and the environmental conditions are known and constant. The algorithm is very fast (<1 ms), has a very small power consumption and the smallest area on silicon. If the algorithm should detect only one group of sounds like voice, there will be many misclassifications and a poor reliability.

“Automatic Threshold Adaptation on Background Noise” Algorithm ALGO2:

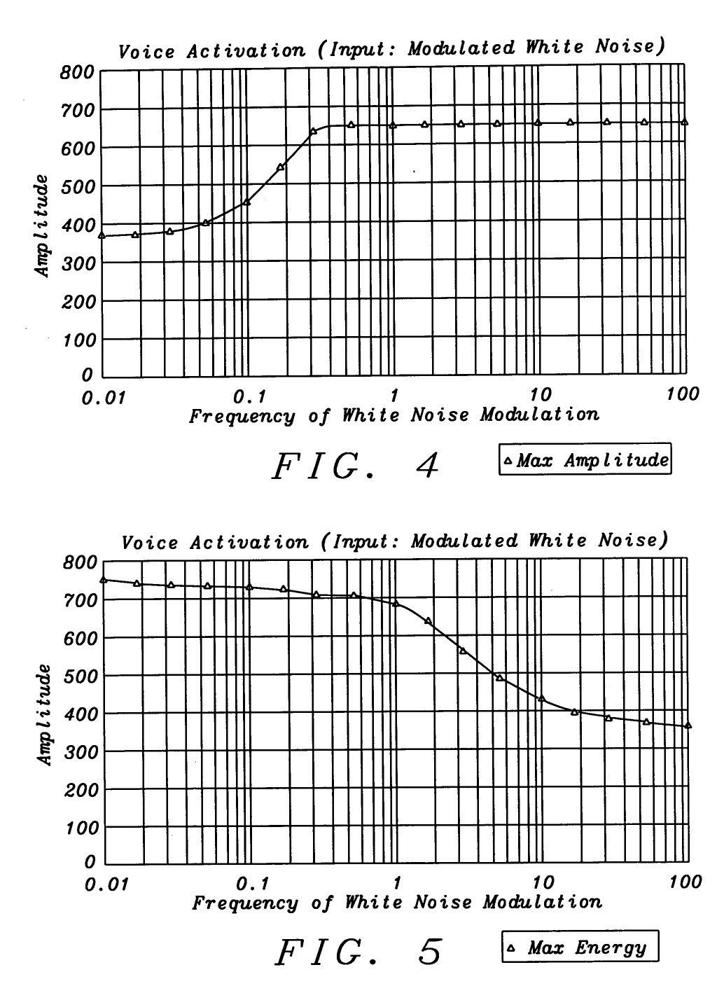

The “Threshold Detection on Signal Amplitude” algorithm ALGO1 can be enhanced by measuring the background noise level and its subtraction from the actual amplitude level, or by increasing the detection threshold accordingly. The white noise modulation diagram in FIG. 4 shows the effect of the adjustment. Slow changing noises can be detected and attenuated. The form and the attenuation can be selected by the noise level algorithm. In principle there are two different possibilities: the first is to average the signal over a short time, and hoping, that there is much more time of noise than activation sounds in the signal. Normally this is the case in fact. Or an algorithm has to measure the noise in the small pauses of speech. This can be used to detect the beginning of words or short phrases in speech recognition systems. The reaction time of this algorithm (ALGO2) is very short (<1 ms), similar to the amplitude threshold detection algorithm. It is used, if SNR is acceptable high and the environmental conditions are “friendly”. Although the noise has to be measured, the needed silicon area is small and the power consumption is low. The misclassifications are reduced and the reliability is better, because of the suppression of slow changing noises.

“Threshold Detection on Signal Energy” Algorithm ALGO3:

As mentioned before, the amplitude is not a measure for the loudness. The signal energy is the low pass filtered square of the signal amplitude. In many cases, the calculation of the square is too complicated and the absolute amplitude values are low pass filtered instead. This is a good substitute for the signal energy. For the diagram shown in FIG. 5 the energy has been calculated by using the absolute values and by filtering these values with a first order low pass filter. The diagram shows the characteristical behavior of the low pass filter. In this case noises with a high modulation frequency (like a jackhammer) will be attenuated. The disadvantage is that the filtering increases the reaction time. Similar to the algorithms before, this algorithm (ALGO3) uses a threshold for the activation detection. It is used, if SNR is large and the environmental conditions are known and constant. Although it is not as fast as the amplitude algorithms, it is fast enough to sign the first phoneme of an activation word. The power consumption is small and the area on silicon is small too. There are however misclassifications happening and the reliability is poor, because only fast changing noises are attenuated. Slow changing noises can lead to a mistake in the activation detection.

“Threshold Detection on Speech Energy” Algorithm ALGO4:

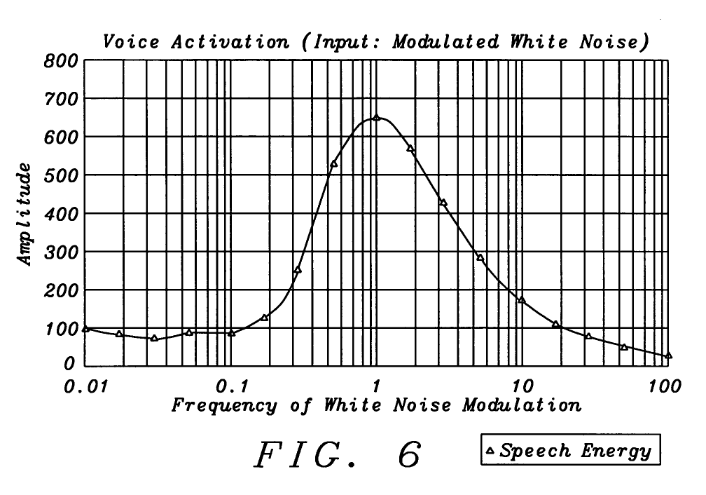

If the audio signal for activation consists of speech (or baby sounds) the signal energy algorithm ALGO3 can be enhanced in a similar way as done for the amplitude detection enhancement in algorithm ALGO2. If the slow changing noises are estimated and subtracted from the signal energy, the speech energy would be the result. As one can see from the diagram in FIG. 6, the sound energy is attenuated in the low frequency region of slow changing noises and in the high frequency region of fast changing noises. Around 1 Hz, where speech modulates, the speech energy is maximal. This algorithm (ALGO4) can be used in low SNR environments too, it is (nearly) independent from environmental conditions. Similar to the energy algorithm ALGO3 this speech energy comparator algorithm (ALGO4) is fast (<15 ms), the power consumption is low and the area of needed silicon is minimal. Because of the attenuation of the different noises, there are only few misclassifications and it has a good reliability.

The crucial points of both algorithms ALGO3 and ALGO4 are thus the application of Noise estimation and espec. Speech estimation methods, implemented by special hardware processing blocks. These signal processing hardware is also needed to realize the following algorithm.

“Signal to Noise Ratio (SNR)” Algorithm ALGO5:

This SNR algorithm (ALGO5) takes into account that a person unconsciously speaks louder if there are high background noises. In this noisy environment the activation should be detected at higher speech energy levels than in environments with low background noises. Said SNR algorithm (ALGO5) sets its activation threshold (of the speech energy) on a defined percentage of the noise energy, which for example can be set to a value of 25% to 400%. In the case of 100% the activation is detected, when the speech energy level is as high (or higher) as the noise energy level. This algorithm should be combined with the previous algorithms, because in silent environments the threshold is so small that calculation errors can lead to a misclassification. A good combination would be to use the speech energy algorithm ALGO4 until the noise energy rises to similar values as the speech energy threshold and then to switch to this SNR algorithm (ALGO5) for higher noises. This algorithm can be used in very low SNR environments; it is (nearly) independent from environmental conditions. Similar to the speech energy algorithm ALGO4 the SNR algorithm is fast (<15 ms), the power consumption is low and the area of needed silicon is minimal. Because of the attenuation of the different noises, there are only few misclassifications and it has a good reliability.

Each algorithm has advantages and disadvantages. To choose the right algorithm it is important to answer the list of questions from above. Helpful therefore would be a summary of all relevant features and characteristical data for each algorithm given at its best in form of a decision table. In the following TABLE 1 an overview for all the pertaining voice activation algorithms and their pertinent characteristics is given, whereby the column headers (on the top of the table) are characterizing the pertinent voice activation algorithm, and the row headers (on the left side of the table) are listing relevant aspects and variables for each algorithm.

TABLE 1
Decision Table for Voice Activation Algorithms

| | | | | | Signal |
|---|---|---|---|---|---|
| | | Adaptive | Signal | Speech | to Noise |
| | Amplitude | Amplitude | Energy | Energy | (SNR) |
| Hardware | Yes | Yes | Yes | Yes | Yes |
| Delay | <1 ms | <1 ms | <15 ms | <15 ms | <15 ms |
| Size | Very Small | Small | Small | Small | Small |
| Power - | Very Low | Low | Low | Low | Low |
| Consumption | | | | | |
| Reliability | Very Low | Low | Low | High | High |
| SNR | >>1 | >1 | >1 | ˜1 | ˜1 |

Remarks:

“Hardware” Yes signifies, that a practical hardware implementation is provided.

“Delay” is the time for producing an activation signal after an activation event.

“Size” should give a hint for the silicon area needed. Precise values cannot be given, because these values depend directly on the technology used.

“SNR” gives a hint about the environmental conditions, where the algorithm should be used.

Recurring back to FIG. 1A it becomes evident now, that this block diagram can be used for realizing a voice activation module circuit with a very limited gate count (<3000), when an external A/D and microphone amplifier can be used to convert the analog microphone signal into digital samples. The module calculates the actual signal energy and differentiates between speech energy and noise energy. A threshold can be set on the amplitude values, the signal energy, the speech energy and the signal to noise ratio (SNR) to perform the voice activation function. Contemplating again the different above described algorithms we find, that all of them are covered by the voice activation module shown in said block diagram, thus the block diagram FIG. 1A is showing a universal structure of building block modules, being able to be tailored/adapted for the realization of all the five algorithms ALGO1 to ALGO5, but not limited to.

Summarizing the essential features of the invention we find, that a circuit and a method are given, to realize a very flexible voice activation system using a modular building block approach, that is adaptively tailored to handle certain relevant and case specific operational characteristics describing most of the possible acoustical differing environmental cases to be found in the field of speech recognition. Included are determinations of “Noise estimation and “Speech estimation” values, done effectively without use of Fast Fourier Transform (FFT) methods or zero crossing algorithms only by analyzing the modulation properties of human voice.

As shown in the preferred embodiments and evaluated by circuit analysis, the novel system, circuits and methods provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A system for a tailorable and adaptable implementation of a voice activation function capable of a practical application of multiple voice activation algorithms, receiving an audio input signal and furnishing a trigger impulse as output signal, comprising:
an analog audio signal pick-up sensor;
an analog/digital converting means digitizing said audio signal and thus transforming said audio signal into a digital signal, then named ‘Digital Audio Input Signal’;
a modular assembly of multiple voice activation algorithm specific circuits made up of building block modules containing processing means for amplitude and energy values of said ‘Digital Audio Input Signal’ as well as and especially for Noise and Speech estimation calculations, intermediate storing means, comparing means, connecting means and means for selecting and operating said voice activation algorithms; and
a means generating said trigger impulse.

2. The system according to claim 1 wherein said analog audio signal pick-up sensor is a microphone.

3. The system according to claim 1 wherein said analog/digital converting means is an electronic analog/digital converter device.

4. The system according to claim 1 wherein said processing means acts on said ‘Digital Audio Input Signal’, i.e. onto its amplitude value used as input variable.

5. The system according to claim 4 wherein said processing means is further acting on processed derivatives of said input variable, i.e. on energy, noise and speech values used as processing variables.

6. The system according to claim 1 wherein said processing means contains an amplitude preparation block.

7. The system according to claim 1 wherein said processing means contains an energy calculation block.

8. The system according to claim 1 wherein said processing means contains a noise estimation block.

9. The system according to claim 1 wherein said processing means contains a speech estimation block.

10. The system according to claim 1 wherein said intermediate storing means is used for storing results of said processing means.

11. The system according to claim 1 wherein said intermediate storing means is used for storing threshold values set-up by said means for selecting and operating said voice activation algorithms.

12. The system according to claim 1 wherein said comparing means compares contents of said intermediate storing means respectively and generates adequate logical output signals.

13. The system according to claim 1 wherein said connecting means is made up of a first connecting means and a second connecting means.

14. The system according to claim 13 wherein said first connecting means serves for connecting said processing means to said ‘Digital Audio Input Signal’ and to each other.

15. The system according to claim 13 wherein said first connecting means serves for respectively connecting outputs of said processing means to inputs of said intermediate storage means.

16. The system according to claim 13 wherein said second connecting means serves for respectively connecting outputs of said intermediate storing means to inputs of said comparing means.

17. The system according to claim 1 wherein said means for selecting and operating said voice activation algorithms allows for a suitable selection of voice activation algorithms by configuring said connecting means for operation.

18. The system according to claim 1 wherein said means for selecting and operating said voice activation algorithms allows for a suitable selection of voice activation algorithms by setting up appropriate threshold values within said intermediate storing means.

19. The system according to claim 1 wherein said trigger generating means receives output signals from said comparing means and is controlled by said means for selecting and operating said voice activation algorithms.

20. The system according to claim 1 wherein said device generating said trigger impulse is made up of combinational logic.

21. A circuit, realizing a voice activation system capable of implementing multiple voice activation algorithms and being composed of four levels of building block modules as well as connection means, receiving an audio input signal and furnishing a trigger impulse as output signal, comprising:
an input terminal as entry for said audio input signal into a first level of modules;
a first level of modules consisting of a set of processing modules including modules for signal amplitude preparation, energy calculation and especially noise and speech estimation;
a second level of modules consisting of a set of intermediate storage modules for threshold and signal values;
a multipurpose connection means in order to transfer said audio input signal to said first level modules and to appropriately connect said first level modules to each other and to said second level of modules;
a third level of modules consisting of comparator modules;
a fourth level of modules as trigger generating means including additional configuration, setup and logic modules; and
an output terminal for said IRQ signal as said output signal in form of said trigger impulse.

22. The circuit according to claim 21 wherein said set of processing modules serves as processing means, which acts on said audio input signal directly, i.e. onto its amplitude value as input variable but also on processed derivatives thereof, i.e. on energy, noise and speech values used as processing variables.

23. The circuit according to claim 21 wherein said set of processing modules includes an “Energy Calculation” module, a “Noise Estimation” module and a “Speech Estimation” module.

24. The circuit according to claim 21 wherein said set of intermediate storage modules for threshold and signal values contains an “Amplitude Value” item with adjacent “Amplitude Threshold” item, an “Energy Value” item with adjacent “Energy Threshold” item, a “Noise Energy Value” item with adjacent “SNR Threshold” item, and finally a “Speech Energy Value” item with adjacent “Speech Threshold” item.

25. The circuit according to claim 21 wherein said multipurpose connection means is employed in order to transfer said audio input signal to said processing modules and to connect said processing modules to each other and to said intermediate storage modules in order to properly evaluate and set-up all processed values for amplitude, energy, noise and speech.

26. The circuit according to claim 21 wherein said four comparator modules include first an “Amplitude Comparator” module, second an “Energy Comparator” module, third an “SNR Comparator” module and fourth a “Speech Comparator” module and where each module is equipped with both threshold and signal value inputs as well as an extra control input, each module comparing the outcoming corresponding value pairs for amplitudes, energies, noise and speech received from said second level modules, and all comparator modules additionally parametrizable by respective control signals also made available from said second level modules.

27. The circuit according to claim 21 wherein said fourth level of modules contains an “IRQ Logic” module, operating as an Interrupt ReQuest (IRQ) signal generating circuit wherein all signal outputs of said former four comparator modules are entering for an activation decision and delivering as output signal said wanted IRQ trigger signal, signalling a recognized event for said voice activation function.

28. The circuit according to claim 21 wherein said fourth level of modules contains an extra “IRQ Status/Config” module for handling all related operations with respect to said IRQ signal generating by and connected to said “IRQ Logic” module.

29. The circuit according to claim 21 wherein said fourth level of modules contains a “Config” module, which is operating in parallel to all formerly introduced modules of level one to four, handling all the necessary analysis functions, as well as all adaptation and configuration settings for all pertaining modules in each case.

30. The circuit according to claim 21 manufactured using modern integrated circuit technologies.

31. The circuit according to claim 30 manufactured in CMOS technology.

32. A circuit for a tailorable voice activation system evaluating an audio input signal and generating a voice activation trigger signal as output and capable of implementing multiple voice activation algorithms thus realizing a very flexible and adaptable voice activation function, built in form of a multilevel structure of building block modules, comprising:
two terminal pins for input and output externally connecting said audio input signal named ‘Digital Audio Input Signal’ and said voice activation trigger signal named ‘Interrupt ReQuest (IRQ) signal’ to said circuit;
a means for processing said ‘Digital Audio Input Signal’ directly as signal amplitude variable and thus generally designated as processing means;
a means for processing derivatives of said signal amplitude variable such as energy, noise and speech signal variables and thus generally designated also as processing means;
a means for intermediately storing the resulting values from said processing means of signal variables and thus generally designated as intermediate storing means;
a means for intermediately storing threshold values for said amplitude, energy, noise and speech signals and thus generally also designated as intermediate storing means;
a means for comparing said intermediately stored and respectively correlated signal variable and threshold values and thus designated as comparing means;
a means for generating a triggering impulse which is signalling a recognized event for said wanted voice activation function and thus designated as trigger impulse generating means;
a means for connecting said ‘Digital Audio Input Signal’ via said input terminal pin and also for connecting said derivative signals thereof to and between said processing means;
a means for connecting said intermediately stored and respectively correlated signal values to said comparing means;
a means for configuring said means for connecting, processing, storing, comparing and trigger impulse generating and thus designated as configuring means; and
a means for setting-up said storage and said comparing means for their corresponding threshold values and also setting-up an IRQ value or a boolean combination of IRQ values for said trigger impulse generating means and thus designated as set-up means, named “IRQ Status/Config” module, and therefore also connected to the pertaining modules in order to furnish said voice activation function.

33. The circuit according to claim 32 wherein said multilevel structure of building block modules is made up of four levels, designated as “First Level Modules” consisting of said processing means, as “Second Level Modules” consisting of said intermediate storing means, as “Third Level Modules” consisting of said comparing means and as “Fourth Level Modules” consisting of said configuring, set-up, and trigger impulse generating means.

34. The circuit according to claim 33 wherein said processing means for said ‘Digital Audio Input Signal’ directly and for said derivatives of said signal amplitude variable such as energy, noise and speech variables consist of several “First Level Modules” serving as general processing means for preparating, calculating and estimating, namely an “Amplitude Processing” block, an “Energy Processing” block, a “Noise Processing” block and a “Speech Processing” block.

35. The circuit according to claim 34 wherein said “Amplitude Processing” block is functioning as an “Amplitude Preparation” module.

36. The circuit according to claim 34 wherein said “Energy Processing” block is functioning as an “Energy Calculation” module.

37. The circuit according to claim 34 wherein said “Noise Processing” block is functioning as a “Noise Estimation” module.

38. The circuit according to claim 34 wherein said “Speech Processing” block is functioning as a “Speech Estimation” module.

39. The circuit according to claim 33 wherein said intermediate storing means consists of several “Second Level Modules”, serving as general storage means for said variable values and their corresponding threshold values, such as an “Amplitude Value” item with correlated “Amplitude Threshold” value, a “Signal Energy Value” item with correlated “Energy Threshold” value, a “Noise Energy Value” item with correlated “Noise Threshold” value, and finally a “Speech Energy Value” item with correlated “Speech Threshold” value.

40. The circuit according to claim 33 wherein said comparing means consists of several “Third Level Modules”, serving as general comparing means and consisting of four comparator modules with both threshold and signal value inputs as well as an extra control input, each comparing said corresponding value pairs for amplitudes, energies, noise and speech, all parametrizable by respective control signals also made available from said “Second Level Modules”.

41. The circuit according to claim 40 wherein said four comparator modules are working as first an “Amplitude Comparator” module, second an “Energy Comparator” module, third a “Noise Comparator” module and fourth a “Speech Comparator” module.

42. The circuit according to claim 33 wherein said configuring means belonging to said “Fourth Level Modules” operates as means for configuring said means for connecting, processing, storing, comparing and trigger generating used within said first, second, third and fourth level modules and operating in parallel to all these modules as a “Status/Config” module, which is operating and handling all the necessary analysis functions, as well as all adaptation and configuration settings for the pertaining modules in each case.

43. The circuit according to claim 33 wherein said set-up means belonging to said “Fourth Level Modules” operates as a means for setting-up said storage and said comparing means for their corresponding threshold values and also setting-up an IRQ value or a boolean combination of IRQ values for said trigger generating means, designated as an “IRQ Status/Config” module and therefore also connected to the pertaining modules in order to furnish said voice activation function.

44. The circuit according to claim 33 wherein said trigger impulse generating means belonging to said “Fourth Level Modules”, is being operated as an Interrupt ReQuest (IRQ) signal generating “IRQ Logic” module, delivering said wanted IRQ trigger signal, which is signalling a recognized event for said wanted voice activation function.

45. The circuit according to claim 32 wherein said means for connecting said ‘Digital Audio Input Signal’ via said input terminal pin and also for connecting said derivative signals thereof respectively and thus also designated as tailorable connection means and generalized as a so called “First Interconnection Layer” for tailorable connecting inputs and outputs to, from and/or between first and second level modules.

46. The circuit according to claim 32 wherein said means for connecting said intermediately stored and correlated values i.e. said resulting values of within first level modules processed variables and their corresponding threshold values as outputs of second level modules to inputs of third level modules for said comparison and thus also designated as adaptable connection means and generalized as a so called “Second Interconnection Layer” providing connection means for the adaptable connecting of outputs and inputs of second and third level modules allowing meaningfully interconnecting all relevant modules in each case.

47. The circuit according to claim 32 manufactured using modern integrated circuit technologies.

48. The circuit according to claim 47 manufactured in CMOS technology.

49. A method for a general tailorable and adaptable voice activation circuits system capable of implementing multiple diverse voice activation algorithms with an input terminal for an audio input signal and an output terminal for a generated voice activation trigger signal and being composed of four levels of building block modules together with two levels of connection layers, altogether being dynamically set-up, configured and operated within the framework of a flexible timing schedule, comprising:
providing as processing means—four first level modules named “Amplitude Processing” block, “Energy Processing” block, “Noise Processing” block and “Speech Processing” block, which act on its input signal named ‘Digital Audio Input Signal’ either directly or indirectly, i.e. either on its amplitude value as input variable or on processed derivatives thereof, i.e. on energy, noise and speech values as processing variables;
providing as storing means four pairs of second level modules designated as value and threshold storing blocks or units respectively, namely for intermediate storage of pairs of amplitude, signal energy, noise energy and speech energy values in each case, named “Amplitude Threshold” and “Amplitude Value”, “Energy Threshold” and “Energy Value”, “Noise Threshold” and “Noise Energy Value”, as well as “Speech Threshold” and “Speech Energy Value”
providing as comparing means within a third level of modules four comparator blocks, named “Amplitude Comparator”, “Energy Comparator”, “Noise Comparator”, and “Speech Comparator”;
providing as triggering means and fourth module level an “IRQ Logic” block together with its “IRQ Status/Config” block, delivering an IRQ output signal for voice activation;
providing also a “First Interconnection Layer” within and between said first level modules for processing said ‘Digital Audio Input Signal’ values from its amplitude, energy, noise and speech variables and said second level modules, whereby said amplitude value of said ‘Digital Audio Input Signal’ may be fed into said “Amplitude Processing” block, and/or into said “Energy Processing” block, and/or into said “Noise Processing” block and/or into said “Speech Processing” block, thus receiving from each other already processed values as possible input and/or control signals separately or in parallel and whereby finally from all said processing the resulting variables with their calculated and/or estimated values are fed into said respective second level storing units, named “Amplitude Value”, “Signal Energy Value”, “Noise Energy Value”, and “Speech Energy Value”;
providing further a “Second Interconnection Layer” between said second and third level of modules for storing and comparing said processed values of said amplitude, energy, noise (SNR) and speech variables, whereby always the corresponding values of threshold and variable result pairs are fed into their respective comparator blocks located within said third level of modules and whereby said comparator blocks may also receive via an extra input additional control signals from others of said second level modules;
providing an extra “Config” block for setting-up and configuring all necessary threshold values and operating states for said blocks within all four levels of modules according to said voice activation algorithm to be actually implemented;
connecting the output of each of said comparators in module level three to said fourth level “IRQ Logic” block as inputs;
establishing a recursively adapting and iteratively looping and timing schedule as operating scheme for said tailorable voice activation circuits system capable of implementing multiple diverse voice activation algorithms and thus being able to being continuously adapted for its optimum operation;
initializing with pre-set operating states and pre-set threshold values a start-up operating cycle of said operating scheme for said voice activation circuit;
starting said operating scheme for said adaptable voice activation circuits system by feeding said ‘Digital Audio Input Signal’ as sampled digital amplitude values into the circuit, namely said “First Interconnection Layer”, for further processing e.g. by calculating said signal energy, and/or by estimating said noise energy and/or said speech energy;
deciding upon said voice activation algorithm to be chosen for actual implementation with the help of crucial variable values such as said amplitude value from said audio signal input variable and also said already calculated and estimated signal energy, noise energy and speech energy values as processing variables critical and crucial for said voice activation algorithm and in conjunction with some sort of a decision table, leading to optimum choices for said voice activation algorithms;
setting-up the operating function of said “First Interconnection Layer” element appropriately with the help of said “Status/Config” block considering the requirements of said voice activation algorithm to be actually implemented for the connections within and between said first and second level modules;
setting-up the operating function of said “Second Interconnection Layer” element appropriately with the help of said “Status/Config” block considering the requirements of said voice activation algorithm to be actually implemented for the connections within and between said second and third level modules;
configuring said necessary operating states e.g. in internal modules each with specific registers by algorithm defining values corresponding to said actually chosen voice activation algorithm for future operations;
setting-up the operating function of said “IRQ Logic” block appropriately with the help of said “IRQ Status/Config” block considering said voice activation algorithm to be actually implemented;
processing continuously within said “Energy Processing” block e.g. said “Signal Energy Value” calculation, acting on said input signal named ‘Digital Audio Input Signal’;
processing continuously within said “Noise Processing” block e.g. said “Noise Energy Value” estimation, which depends on its input signal, e.g. said already formerly calculated “Signal Energy Value”;
processing continuously within said “Speech Estimation” block e.g. said “Speech Energy Value”, which depends on its input signal, e.g. said already formerly calculated “Signal Energy Value”;
storing within its corresponding storing units located within module level two the results of said preceding “Amplitude Processing”, “Energy Processing”, “Noise Processing” and “Speech Processing” operations, namely said “Amplitude Value”, “Signal Energy Value”, “Noise Energy Value”, and “Speech Energy Value” all taken directly or indirectly from said ‘Digital Audio Input Signal’;
setting-up within said storing units said respective threshold values named “Amplitude Threshold”, “Energy Threshold”, “Noise Threshold” and “Speech Threshold” corresponding to said actually chosen voice activation algorithm for future comparing operations;
comparing with the help of said “Amplitude Comparator”, “Energy Comparator”, “Noise Comparator”, and “Speech Comparator” said “Amplitude Threshold” and “Amplitude Value”, said “Energy Threshold” and “Signal Energy Value”, said “Noise Threshold” and “Noise Energy Value”, as well as said “Speech Threshold” and “Speech Energy Value”;
evaluating the outcome of the former comparing operations within said “IRQ Logic” block with respect to said earlier set-up operating function;
generating, depending on said “IRQ Logic” evaluation in the case where applicable a trigger event as IRQ impulse signalling a recognized speech element for said voice activation; and
re-starting again said once established operating scheme for said voice activation circuits system from said starting point above and continue its looping schedule.

50. The method according to claim 49, wherein said audio input signal is picked-up by some acoustical sensor.

51. The method according to claim 50 wherein said acoustical sensor is a microphone.

52. A method for a tailorable and adaptable voice activation circuits system capable of implementing multiple diverse voice activation algorithms with an input terminal for an audio input signal and an output terminal for a generated voice activation trigger signal and being composed of four levels of building block modules together with two sets of connections, altogether being set-up, configured and operated within the framework of a timing schedule, comprising:
providing as processing means three first level modules named “Energy Calculation” block, “Noise Estimation” block and “Speech Estimation” block, which act on its input signal named ‘Digital Audio Input Signal’ directly, i.e. on its amplitude value as input variable and also on processed derivatives thereof, i.e. on energy, noise and speech values as processing variables;
providing as storing means four pairs of second level modules designated as value and threshold storing blocks or units respectively, namely for intermediate storage of pairs of amplitude, signal energy, noise energy and speech energy values in each case, named “Amplitude Threshold” and “Amplitude Value”, “Energy Threshold” and “Energy Value”, “SNR Threshold” and “Noise Energy Value”, as well as “Speech Threshold” and “Speech Energy Value”;
providing as comparing means within a third level of modules four comparator blocks, named “Amplitude Comparator”, “Energy Comparator”, “Noise (SNR) Comparator”, and “Speech Comparator”;
providing as triggering means and fourth module level an “IRQ Logic” block together with its “IRQ Status/Config” block, delivering an IRQ output signal for voice activation;
providing also a first set of interconnections within and between said first level modules for processing said ‘Digital Audio Input Signal’ values from its amplitude, energy, noise (SNR) and speech variables and said second level modules, whereby said amplitude value of said ‘Digital Audio Input Signal’ is fed into said “Energy Calculation” block and in turn both estimation blocks, for “Noise Estimation” and for “Speech Estimation” namely, receive from it said therein calculated signal energy value in parallel and whereby finally from all said resulting variables their calculated and estimated values are fed into said respective second level storing units, named “Amplitude Value”, “Energy Value”, “Noise Energy Value”, and “Speech Energy Value”;
providing further a second set of interconnections between said second and third level of modules for storing and comparing said processed values from said amplitude, energy, noise (SNR) and speech variables, whereby always the corresponding values of threshold and variable result pairs are fed into their respective comparator blocks and only said “Noise (SNR) Comparator” block receives via an extra input from said “Speech Energy Value” block said speech energy value as additional control signal;
providing an extra “Config” block for setting-up and configuring all necessary threshold values and operating states for said blocks within all four levels of modules according to said voice activation algorithm to be actually implemented;
connecting the output of each of said comparators in module level three to said fourth level “IRQ Logic” block as inputs;
establishing a recursively adapting and iteratively looping and timing schedule as operating scheme for said tailorable voice activation circuits system capable of implementing multiple diverse voice activation algorithms and thus being able to being continuously adapted for its optimum operation;
initializing with pre-set operating states and pre-set threshold values a start-up operating cycle of said operating scheme for said voice activation circuit;
starting said operating scheme for said adaptable voice activation circuits system by feeding said ‘Digital Audio Input Signal’ as sampled digital amplitude values into the circuit, by calculating said signal energy, and estimating said noise energy (SNR) and said speech energy;
deciding upon said voice activation algorithm to be chosen for actual implementation with the help of crucial variable values such as said amplitude value from said audio signal input variable and also said already calculated and estimated signal energy, noise energy and speech energy values as processing variables critical and crucial for said voice activation algorithm and in conjunction with some sort of a decision table, leading to optimum choices for said voice activation algorithms;
configuring said necessary operating states e.g. in internal modules each with specific registers by algorithm defining values corresponding to said actually chosen voice activation algorithm for future operations;
setting-up the operating function of said “IRQ Logic” block appropriately with the help of said “IRQ Status/Config” block considering said voice activation algorithm to be actually implemented;
calculating continuously within said “Energy Calculation” block said “Energy Value”, acting on said input signal named ‘Digital Audio Input Signal’;
estimating continuously within said “Noise Estimation” block said “Noise Energy Value”, which depends on its input signal, namely said already formerly calculated “Energy Value”;
estimating continuously within said “Speech Estimation” block said “Speech Energy Value”, which depends on its input signal, namely said already formerly calculated “Energy Value”;
storing within its corresponding storing units located within module level two the results of said preceding “Energy Calculation”, “Noise Estimation” and “Speech Estimation” operations, namely said “Energy Value”, “Noise Energy Value”, and “Speech Energy Value” as well as said “Amplitude Value” taken directly from said ‘Digital Audio Input Signal’;
setting-up within said storing units said respective threshold values named “Amplitude Threshold”, “Energy Threshold”, “SNR Threshold” and “Speech Threshold” corresponding to said actually chosen voice activation algorithm for future comparing operations;
comparing with the help of said “Amplitude Comparator”, “Energy Comparator”, “Noise (SNR) Comparator”, and “Speech Comparator” said “Amplitude Threshold” and “Amplitude Value”, said “Energy Threshold” and “Energy Value”, said “SNR Threshold” and “Noise Energy Value”, as well as said “Speech Threshold” and “Speech Energy Value”;
evaluating the outcome of the former comparing operations within said “IRQ Logic” block with respect to said earlier set-up operating function;
generating, depending on said “IRQ Logic” evaluation in the case where applicable a trigger event as IRQ impulse signalling a recognized speech element for said voice activation; and
re-starting again said once established operating scheme for said voice activation circuits system from said starting point above and continue its looping schedule.

53. The method according to claim 52, wherein said audio input signal is picked-up by some acoustical sensor.

54. The method according to claim 53 wherein said acoustical sensor is a microphone.
